(19) United States
(12) Patent Application Publication
(10) Pub. No.: US 2017/0032128 A1
(43) Pub. Date: Feb. 2, 2017

(54) Processing Method for Fuzzy Checking Securities Information

(71) Applicant: Fonestock Technology Inc., Taipei City (TW)

(72) Inventors: Albert Chu Tsung Chen, Taipei City (TW); Yi-Hsuan Kuo, Taipei City (TW)

(73) Assignee: Fonestock Technology Inc., Taipei City (TW)

(21) Appl. No.: 14/813,884

(22) Filed: Jul. 30, 2015

(51) Int. Cl. G06F 21/57

(52) U.S. Cl. CPC G06F 21/577; G06F 2221/034

(57) ABSTRACT

A processing method for fuzzy checking securities information, which is employed in a user device of a securities information processing system, allows a user to execute a securities suggesting setting function in order to configure at least one securities suggesting condition composed of at least one candlesticks checking condition. In addition, each candlesticks checking condition includes a fuzzy checking condition which can be defined by the user. When the user device receives a plurality of securities information, these securities information are checked to see if any of them fulfills all of the fuzzy checking conditions of candlesticks checking conditions contained in any of the securities suggesting conditions. If the result is positive, then the user device suggests and prompts the fulfilled securities information to the user so as to provide a reference to the user for determining when to buy or sell the securities in which the user is interested.

### BACKGROUND OF INVENTION

1. Field of the Invention

The invention relates to a processing method for fuzzy checking securities information, and more particularly to the processing method that allows the user to configure at least one securities suggesting condition composed of at least one fuzzy checking condition of at least one candlesticks checking condition without further programming, and, when any of the securities information meets the securities suggesting condition, an alarm for highlighting this situation is issued.

2. Description of the Prior Art

As the information technology rapidly grows, convenience and speed in accessing the information are two of major progress in this industry. Versatile portable wireless communication apparatuses are merged into this trend to provide people convenience and many demands in ordinay life. For example, those portable wireless communication apparatuses include various handheld devices (such as mobile phones and cellular phones), smart phones, stock trackers, personal digital assistants with communication functions, notebook or tablet computers with wireless communication functions, and the like.

The aforesaid progresses in the information technology, especially for the wireless communication apparatuses, are both in the hardware manifold and also in the software manifold. The applications include financial investments, jobs, entertainments, information accessing and so on. A typical example in the financial investments is the electronic trading of securities (including stocks, bonds and futures) through wireless communication apparatuses. Appropriate wirelsss communication apparatuses for electronically trading the securities can perform electronic order placing and also provide real-time trading information in the securities market, such that the user may sort from the huge information sea of the securities and can thereby perform the optimal timing for buying or selling a taget security or securities.

For those users who frequently perform trading of the securities, candlesticks of the historical or intraday trading record of the securities are the important clues for judging the turning point of buy and sell. By evaluating the historical candlesticks chart of a specific security, the timing and pricing for buying or selling the securities can be can better determined. Hence, if a relevant processing method for securities information can be provided to automatically investigate trading information of plural securities and further to alarm the user whether or not some securities meet specific variations of the candlesticks, the determination of an optimal trading point for the concerned securities would be much simple and easy.

Nevertheless, in viewing of service and technical analytical information currently provided by the securities professionals, it is usual that plenty of terminologies and professional languages for securities industry are involved, such that the ordinary users would be driven away because of lacking related knowledge in this field. As a result, these valuable technical analytical information such as the candlesticks charts may become useless to the ordinary people, even though they do need such information to advise the trading timing and pricing for their own securities

### SUMMARY OF THE INVENTION

Accordingly, it is the primary object of the present invention to provide a processing method for fuzzy checking securities information, which is employed in a user device of a securities information processing system and allows the user of the user device to configure least one securities suggesting condition composed of at least one fuzzy checking condition of at least one candlesticks checking condition by executing a securities suggesting setting function. In this processing method, when the user device receives a plurality of securities information, the securities information is/are checked to see if any one thereof fulfills corresponding fuzzy checking conditions of all of the candlesticks checking conditions contained in any one of the securities suggesting conditions. If the result is a “Yes” or positive, an alarm signal is issued and the concerned securities information is displayed on the user device for user's viewing and hopefully helping the user to determine timing and pricing for trading the interested securities. Through the aforesaid fuzzy checking provided by the present invention, a considerable amount of securities information can be located to fulfill the securities suggesting condition configured by the user, so that checking results with better reference values can be obtained.

It is another object of the present invention to provide a processing method for fuzzy checking securities information, which allows the user to select a specific security and further to check if historical candlesticks information of the security meets any one of the securities suggesting conditions. If positive, at least one of the historical or intraday candlesticks chart of the security is displayed. Also, the satisfied securities suggesting condition is labeled to the historical or intraday candlesticks chart.

By providing the present invention, the user can sort specific securities that meet the candlesticks checking conditions, and can configure the manipulation of the candlesticks checking conditions by pictures or any visional medium the like, such that the user can judge in a straight forward manner (without tedious pondering or mathematical computations) which securities or the preset candlesticks checking condition is met and is good for trading. Thereby, even for an ordinary people without sophistic securities knowledge, he/she can still employ the securities information processing system and method to determine a preferred timing or pricing for selling or buying his/her securities.

In one aspect of the present invention, the processing method for fuzzy checking securities information, applied to a user device of a securities information processing system, comprising the steps of:

Step (A): Setting at least one securities suggesting condition in the user device and the user device receiving a plurality of foreign securities information; wherein each of the at least one securities suggesting condition includes at least one candlesticks checking condition and each of the at least one candlesticks checking condition further includes an OPEN position, a CLOSE position, a HIGH position, a LOW position and at least one fuzzy checking condition of foregoing meaningful positions in a predetermined time period; wherein the OPEN position, the CLOSE position, the HIGH position and the LOW position are all expressed by relative percentages not absolute values; wherein a difference between the HIGH position and the LOW position of each of the at least one candlesticks checking condition is no more than twice of a predetermined price limit; wherein each of the plurality of securities information includes at least one trading information of a security within a specific time duration, and the specific time duration larger than the predetermined time period is divided into a plurality of the predetermined time periods; wherein, in each of the plurality of the predetermined time periods, the at least one trading information further includes an OPEN, a CLOSE, a HIGH and a LOW, and each of the OPEN, the CLOSE, the HIGH and the LOW is expressed by an absolute value; and

Step (B): the user device analyzing each of the plurality of securities information and checking if any of the securities information meets any of the at least one securities suggesting condition in the fuzzy checking conditions of the meaningful positions of every one of the at least one candlesticks checking condition thereof, and issuing an alarm signal if positive by accompanying an operation of displaying the any of the securities information on the user device.

In the present invention, the fuzzy checking conditions of the meaningful positions include: an upper-shadow-line fuzzy checking condition, a solid-line fuzzy checking condition and a lower-shadow-line fuzzy checking condition.

The upper-shadow-line fuzzy checking condition is derived in percentage terms by dividing a value of subtracting the larger one of the OPEN and the CLOSE from the HIGH by the OPEN,

The solid-line fuzzy checking condition is derived in percentage terms by dividing an absolute value of the difference between the OPEN and the CLOSE by the OPEN.

The lower-shadow-line fuzzy checking condition is derived in percentage terms by dividing a value of substracting the LOW from the smaller one of the OPEN and the CLOSE by the OPEN.

In another aspect of the present invention, the processing method for fuzzy checking securities information, employed in a securities information processing system having a server and at least one user device, the server and the at least one user device being to receive a plurality of foreign historical securities trading information, comprising the steps of:

Step (1): storing a plurality of securities suggesting conditions into at least one of the server and the user device;

Step (2): manipulating the user device to choose a security; and

Step (3): checking if the historical trading information of the chosen security meets any one of the securities suggesting conditions, displaying a historical candlesticks chart of the chosen security if positive, and labeling the any one of the securities suggesting conditions in the historical candlesticks chart.

In one embodiment of the present invention, the user device further includes a touch screen, the securities suggesting condition is able to be configured by one user of the user device, and configuring of the securities suggesting condition includes the steps of:

Step (A1): executing a securities suggesting setting function;

Step (A2): the securities suggesting setting function displaying a plurality of neighboring initial candlesticks on the touch screen;

Step (A3): if any one of the plurality of initial candlesticks is clicked, entering a candlestick adjusting function of the clicked initial candle, and displaying at least an enlarged candlestick of the clicked initial candlestick on the touch screen; wherein the enlarged candlestick has an OPEN touch point, a CLOSE touch point, a HIGH touch point and a LOW touch point, and the OPEN touch point, the CLOSE touch point, the HIGH touch point and the LOW touch point are individually referred to respective percentages;

Step (A4): checking if a depress-and-pull operation is performed by the user on any one of the OPEN touch point, the CLOSE touch point, the HIGH touch point and the LOW touch point of the enlarged candle, adjusting, if positive, the percentage corresponding to the any one of the OPEN touch point, the CLOSE touch point, the HIGH touch point and the LOW touch point of the enlarged candlestick according to the user till the depress-and-pull operation ends, then adjusting a color and a shape of the enlarged candlestick according to a result of user's depress-and-pull operation so as to form an adjusted candle, and replacing the enlarged candlestick with the adjusted candlestick on the touch screen; and

Step (A5): going back to Step (A3), replacing the clicked intial candlestick on the touch screen with a minimized candlestick of the adjusted candlestick of Step (A4). When the user completes all candle-adjustment upon the plurality of the initial candles, and then assigning respective percentages corresponding to the OPEN touch point, the CLOSE touch point, the HIGH touch point and the LOW touch point of each of the adjusted candlesticks to update the respective candlesticks checking condition.

In one embodiment of the present invention, the step of the user configuring the securities suggesting condition can further include a step of the user configuring a trendline or selecting a preset trendline, in which the trendline can be, but not limited to, an uptrend candlestick line, a downtrend candlestick line and a fluctuating candlestick line.

In one embodiment of the present invention, the depress-and-pull operation in the Step (A4) is performed by pulling up and down to change the respective percentage; and

wherein, as the depress-and-pull operation is performed upon the enlarged candlestick directly on the touch screen, the entire enlarged candlestick as well as the OPEN touch point, the CLOSE touch point, the HIGH touch point and the LOW touch point are all synchronously pulled;

wherein, as the depress-and-pull operation is performed only upon the OPEN touch point on the touch screen, only the OPEN touch point is pulled;

wherein, as the depress-and-pull operation is performed only upon the CLOSE touch point on the touch screen, only the CLOSE touch point is pulled;

wherein, as the depress-and-pull operation is performed only upon the HIGH touch point on the touch screen, only the HIGH touch point is pulled;

wherein, as the depress-and-pull operation is performed only upon the LOW touch point on the touch screen, only the LOW touch point is pulled;

wherein, as the OPEN touch point is positioned higher that the CLOSE touch point, the enlarged candlestick is green; wherein, as the OPEN touch point is positioned lower that the CLOSE touch point, the enlarged candlestick is red; and wherein, as the depress-and-pull operation leads to a high-low position switch between the OPEN touch point and the CLOSE touch point, the color of the enlarged candlestick is changed as well.

In one embodiment of the present invention, in the Step (A4), as the depress-and-pull operation is performed simultaneously upon the HIGH touch point and the LOW touch point on the touch screen, the OPEN touch point, the CLOSE touch point, the HIGH touch point and the LOW touch point of the enlarged candlestick are proportionally changed accordingly.

In one embodiment of the present invention, in the Step (A3), as the candlestick adjusting function is performed, the touch screen shows the enlarged candlestick and some mini candlesticks with preset colors and sizes; and wherein, as any one of the mini candlestick is clicked, the color and size of the clicked mini candlestick is applied to the enlarged candle.

In one embodiment of the present invention, between the Step (A4) and the Step (A5), a Step (A4a) is further included as follows:

displaying the enlarged candlestick, a corresponding input block of the upper-shadow-line fuzzy checking condition, a corresponding input block of the solid-line fuzzy checking condition and a corresponding input block of the lower-shadow-line fuzzy checking condition on the touch screen;

wherein the user can click the input block of the upper-shadow-line fuzzy checking condition to configure the upper-shadow-line fuzzy checking condition to be one of a value substantially equal to a percentage value, a value larger than a percentage value, a value smaller than a percentage value and an arbitrary length;

wherein the user can click the input block of the solid-line fuzzy checking condition to configure the solid-line fuzzy checking condition to be one of a value substantially equal to a percentage value, a value larger than a percentage value, a value smaller than a percentage value and an arbitrary length;

wherein the user can click the input block of the lower-shadow-line fuzzy checking condition to configure the lower-shadow-line fuzzy checking condition to be one of a value substantially equal to a percentage value, a value larger than a percentage value, a value smaller than a percentage value and an arbitrary length.

All these objects are achieved by the processing method for fuzzy checking securities information described below.

### BRIEF DESCRIPTION OF THE DRAWINGS

The present invention will now be specified with reference to its preferred embodiment illustrated in the drawings, in which:

FIG. 1 shows schematically an embodiment of the securities information processing system in accordance with the present invention;

FIG. 2 is a schematic view of the built-in securities suggesting conditions on the user device of the securities information processing system in accordance with the present invention;

FIG. 3 is a schematic view of the configurable securities suggesting conditions on the user device of the securities information processing system in accordance with the present invention;

FIG. 4A is a schematic view of a “My pattern” suggesting window of the configured security on the user device of the securities information processing system in accordance with the present invention;

FIG. 4B is a schematic view of plural candlesticks of the configured security on the user device of the securities information processing system in accordance with the present invention;

FIG. 4C is a schematic view of plural candlestick charts of the configured security on the user device of the securities information processing system in accordance with the present invention;

FIG. 4D is a schematic view of a configuration window of the configured security on the user device of the securities information processing system in accordance with the present invention;

FIG. 5 is a schematic view of an enlarged candlestick of the configured security on the user device of the securities information processing system in accordance with the present invention;

FIG. 6A and FIG. 6B show steps of a first embodiment of the depress-and-pull operation upon a candlestick of the processing method for fuzzy checking securities information in accordance with the present invention;

FIG. 7A and FIG. 7B show steps of a second embodiment of the depress-and-pull operation upon a candlestick of the processing method for fuzzy checking securities information in accordance with the present invention;

FIG. 8A and FIG. 8B show steps of a third embodiment of the depress-and-pull operation upon a candlestick of the processing method for fuzzy checking securities information in accordance with the present invention;

FIG. 9A and FIG. 9B show steps of a fourth embodiment of the depress-and-pull operation upon a candlestick of the processing method for fuzzy checking securities information in accordance with the present invention;

FIG. 10A and FIG. 10B show steps of a fifth embodiment of the depress-and-pull operation upon a candlestick of the processing method for fuzzy checking securities information in accordance with the present invention;

FIG. 11A and FIG. 11B show steps of a sixth embodiment of the depress-and-pull operation upon a candlestick of the processing method for fuzzy checking securities information in accordance with the present invention;

FIG. 12A and FIG. 12B show steps of a seventh embodiment of the depress-and-pull operation upon a candlestick of the processing method for fuzzy checking securities information in accordance with the present invention;

FIG. 13A, FIG. 13B and FIG. 13C show three of various arrangements of three preset or configured candlesticks of the processing method for fuzzy checking securities information in accordance with the present invention;

FIG. 14 is a flowchart of applying a first embodiment of the processing method for fuzzy checking securities information in accordance with the present invention to a user device in a securities information processing system;

FIG. 15A shows a touch screen of a user device with built-in preset securities suggesting conditions for the processing method for fuzzy checking securities information in accordance with the present invention;

FIG. 15B shows another screen of FIG. 15A, on which specific securities meeting the securities suggesting conditions are displayed;

FIG. 15C shows a further screen of FIG. 15A, on which details of securities to be tracked are displayed;

FIG. 16 is a flowchart of applying a second embodiment of the processing method for fuzzy checking securities information in accordance with the present invention to a user device in a securities information processing system;

FIG. 17A through FIG. 17X illustrate individually the preset candlsticks arrangements for the processing method for fuzzy checking securities information in accordance with the present invention;

FIG. 18 is a schematic view to show an embodiment of configuring of the fuzzy checking conditions upon an enlarged candlestick of the configured security on the user device of the securities information processing system in accordance with the present invention; and

FIG. 19A through FIG. 19E demonstrates various practical configuring for FIG. 18.

### DESCRIPTION OF THE PREFERRED EMBODIMENT

The invention disclosed herein is directed to a processing method for fuzzy checking securities information. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

The processing method for fuzzy checking securities information of the present invention, employed in a user device of a securities information processing system, can allow the user of the user device to configure at least one securities suggesting condition composed of at least one fuzzy checking condition of at least one candlesticks checking condition by executin a securities suggesting setting function. When the user device receives a plurality of securities information, these securities information are checked to see if any one of them fulfills corresponding fuzzy checking conditions of all of the candlesticks checking conditions contained in any one of the securities suggesting condition. If the result is “YES”, then the user device suggests and prompts the fulfilled securities information to the user so as to provide a reference to the user for determining when to buy or sell the securities in which the user is interested. Through the aforesaid fuzzy checking provided by the present invention, a considerable amount of securities information can be located to fulfill the securities suggesting condition configured by the user, so that checking results with better reference values can be obtained.

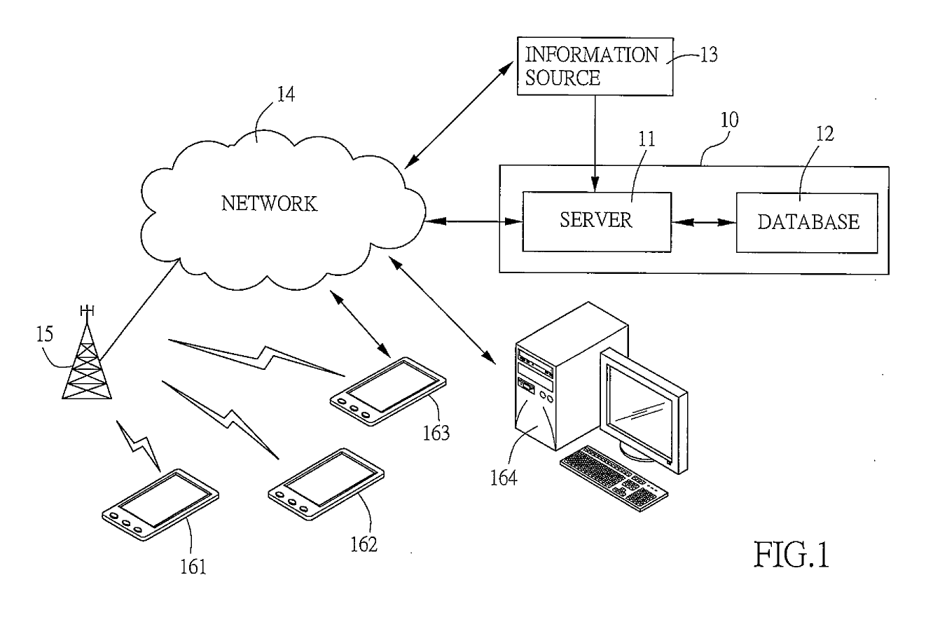

Referring now to FIG. 1, a schematic view of an embodiment of the securities information processing system in accordance with the present invention is shown.

In this embodiment, the securities information processing system includes a server 11, at least one database 12, an information source 13, a communicative media 14, a communicative service system 15, and a plurality of user devices 161, 162, 163, 164. The server 11 and the database 12 are mainly integrated to form the securities information service system 10. The server 11 can receive a plurality of trading information of the securities from the at least one information source 13, analyze the received trading information of the securities, and then store them into the at least one database 12. The server 11 can establish per request connections with the user devices 161, 162, 163, 164 via a communicative media 14, and allow these user devices 161, 162, 163, 164 to login for receiving services thereof. These services can include, but not limited to, the downloading of the trading information of the securities and/or related statistic data stored in the at least one database 12. In the present invention, these trading information of the securities and/or related statistic data can be simply called the securities information.

These user devices 161, 162, 163, 164, the server 11 and the information sources 13 can be linked via the communicative media 14 provided by the at least one communicative service system 15. In this embodiment, the securities information processing system 10 is to provide information services related the securities, where the securities can include, but not limited to, stocks, futures, warrants, funds, bonds, and so on. The information source 13, as a data source or provider from which the server 11 and these user devices 161, 162, 163, 164 can retrieve the trading information of the securities including the historical and intraday data, can be, but not limited to, a stock exchange, a securities dealer, a bank, a news media, a TV or broadcast media, and any company the like. The communicative service system 15 can be, but not limited to, GSM850/900/1800/1900, CDMA, WCDMA, PHS, GPRS, WiMAX, LTE, and any communicative system he like. The user device 161, 162, 163 or 164 can be, but not limited to, a stock-tracking machine with a touch screen, a PDA, a smart phone, a handheld electronic apparatus, a tablet computer wih a touch screen, a notebook computer, and a desktop computer. The communicative media 14 can include at least one of a mobile phone communicative media, a wireless communicative netwok media, and an internet network media.

In the present invention, the processing method for fuzzy checking securities information is applied to any user device 161, 162, 163 or 164 of the securities information processing system. The user device 161, 162, 163 or 164 can include a touch screen for the user to perform the processing method for fuzzy checking securities information through the touch screen. In one embodiment, the processing method for fuzzy checking securities information can mainly include the two following steps (A) and (B).

Step (A): Setting at least one securities suggesting condition in the user device and the user device receiving a plurality of foreign securities information; wherein each of the at least one securities suggesting condition includes at least one candlesticks checking condition and each of the at least one candlesticks checking condition further includes an OPEN position, a CLOSE position, a HIGH position and a LOW position in a predetermined time period; wherein the OPEN position, the CLOSE position, the HIGH position, the LOW position and at least one fuzzy checking condition of foregoing meaningful positions are all expressed by relative percentages not absolute values; wherein a difference between the HIGH position and the LOW position of each of the at least one candlesticks checking condition is no more than twice of a predetermined price limit (for example, ±10% price variation per day for Taiwan Stock Exchange Corporation (TWSE)); wherein each of the plurality of securities information includes at least one trading information of a security within a specific time duration (for example, several days, several weeks, several 10-days and so on), and the specific time duration larger than the predetermined time period is divided into a plurality of the predetermined time periods; wherein, in each of the plurality of the predetermined time periods, the at least one trading information further includes an OPEN, a CLOSE, a HIGH and a LOW, and each of the OPEN, the CLOSE, the HIGH and the LOW is expressed by an absolute value (i.e. a positive number).

Step (B): the user device analyzing each of the plurality of securities information and checking if, within the specific time duration, the OPEN, the CLOSE, the HIGH and the LOW of a plurality of predetermined time period of any one of the securities information meet any one of the at least one securities suggesting condition in the fuzzy checking conditions of the meaningful positions of every one of the at least one candlesticks checking condition thereof, and issuing an alarm signal if positive by accompanying an operation of displaying the any one of the securities information to the user for his/her determination upon buying or selling the securities he'she interested in. On the other hand, if the checking is negative, then no alarm signal is generated.

In the present invention, the fuzzy checking conditions of the meaningful positions include: an upper-shadow-line fuzzy checking condition, a solid-line fuzzy checking condition and a lower-shadow-line fuzzy checking condition. The upper-shadow-line fuzzy checking condition is derived in percentage terms by dividing a value of subtracting the larger one of the OPEN and the CLOSE from the HIGH by the OPEN. The solid-line fuzzy checking condition is derived in percentage terms by dividing an absolute value of the difference between the OPEN and the CLOSE by the OPEN. The lower-shadow-line fuzzy checking condition is derived in percentage terms by dividing a value of substracting the LOW from the smaller one of the OPEN and the CLOSE by the OPEN.

In the Step (B) of this embodiment, while in analyzing and comparing the securities information and the candlesticks checking conditions, it is not necessary that the percentage values of the OPEN, the CLOSE, the HIGH and the LOW of the securities information shall be exactly the same as the corresponding values of the specific candlesticks checking condition. Practically, as long as the aforesaid percentage values of the securities information and the shape of the candlestick are fallen within acceptable variation ranges defined by the fuzzy checking conditions of the candlesticks checking condition, a “YES” or positive checking result can be achieved.

In this embodiment, the specific time duration shall be larger in several times than the predetermined time period, and the scale shall be determined by the user. For example, the predetermined time period can be 5 minutes, a day, five days, a working week, 20 days or a working month. In the case that the predetermined time period is a 5-mimute period, the candlesticks chart is then called as a 5-min candlesticks chart. Similarly, in the case that the predetermined time period is a day, then the candlesticks chart is called as a daily candlesticks chart.

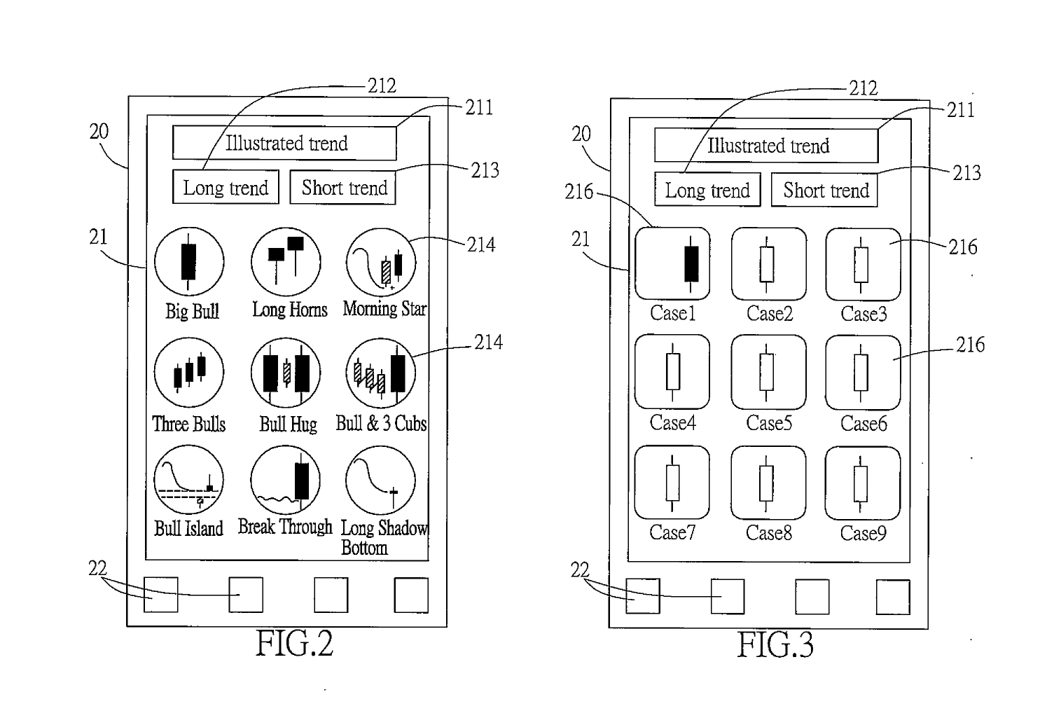

Referring now to FIG. 2, a schematic view of the built-in securities suggesting conditions on the user device 20 of the securities information processing system in accordance with the present invention is shown. In this user device 20, a touch screen 21 and plenty of solid or virtual buttons 22 are included. Further, the user device 20 of this invention can have wireless communicative functions and constructions for some modem electronic devices already in the marketplace such as smart phones, stock trackers, tablet computers, notebook computers, and any the like. In the embodiment as shown in FIG. 2, the securities suggesting conditions can be preset and built in the user device 20. As the processing method for fuzzy checking securities information is employed in the user device 20 as the aforesaid Step (A), some function blocks would be provided onto the touch screen 21. These function blocks may include a title block 211, at least one function block, and a plurality of preset candlestick formulations 214.

The title block 211 is for illustrating the name of the purpose of the incident page. For example, the name “Typical patterns” stands for the situation that the user can click the preset candlestick formulations 214 on the touch screen 21 so as to analyse rapidly and screen the securities information meeting the selection.

The function blocks 212, 213 can be clicked to perform the processing defined for the function blocks 212, 213. For example, in the case that the “Long trend” function block 212 is clicked, a plurality of preset candlestick formulations 214 that are directed to a buy of the securities would be displayed on the touch screen 21. On the other hand, in the case that the “Short trend” function block 213 is clicked, a plurality of preset candlestick formulations 214 that are directed to a sell of the securities would be displayed on the touch screen 21.

Each of the preset candlestick formulations 214 includes one or several candles. The color and the shape of the candlestick are essential to a formulation of a candlesticks checking condition. As all the preset candlesticks checking conditions featured by the candlesticks of the preset candlestick formulations 214 are met simultaneously, the securities suggesting condition in correspondence with the preset candlestick formulations 214 is said to be matched. Namely, when the historical or intraday candlesticks chart of a security during the specific time duration demonstrates any or more of the preset candlestick formulations 214, then the security is deemed as a security that satisfies the preset securities suggesting conditions. At this time, the user device 20 would issue an alarm signal, and the name or code of the security that satisfies the securities suggesting condition would be displayed on the touch screen. Further, a symbol, a word, a sound or a flash would be accompanied on the touch screen 21 to highlight this alarm signal. Upon such an arrangement, the user would be definitely driven to notice the security satisfying the securities suggesting conditions in the name, the code, and also the related detaiked information.

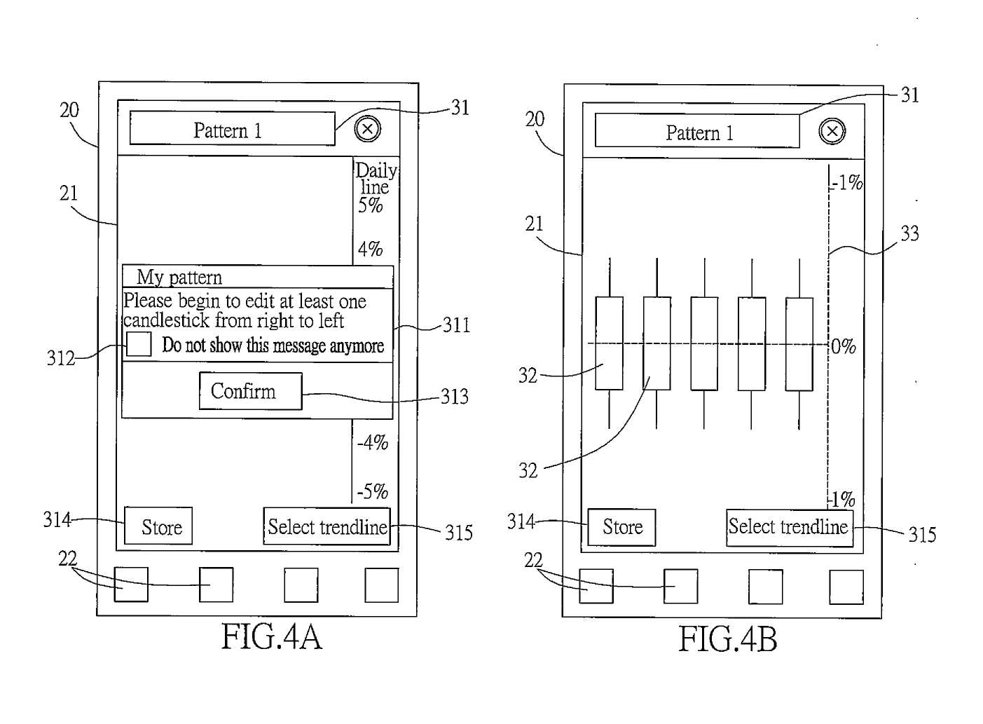

Referring now to FIG. 3, a schematic view of the configurable securities suggesting conditions on the user device 20 of the securities information processing system in accordance with the present invention is shown. In the present invention, the securities suggesting conditions can also be configured by the user of the user device 20. In one embodiment, in the aforesaid Step (A), the method for the user to configure the securities suggesting conditions includes the following Steps (A1) to (A5).

Step (A1): The user operates the user device 20 to execute a securities suggesting setting function of the processing method for fuzzy checking securities information in accordance with the present invention. Simultaneously, a page resembled to that shown in FIG. 3 can appear on the touch screen 21 of the user device 20, in which the aforesaid title block 211, the function blocks 212, 213 an also at least one configured illustration 216 (nine shown in the figure) are shown. Before the user begins to setup his/her own configurations, each of the configured illustrations 216 is simply an empty, light-colored and dashed candle, which explains that the configured illustration 216 is yet to be filled in the securities suggesting conditions. As long as the configured illustration 216 is setup wih the securities suggesting conditions by the following user's operations, the setup-already configured illustration 216 would appear in a style of the user configured candlestick like the Case 1 of FIG. 3. In the present invention, each setup-already candle, in both the color and the shape, is an essential element for the user-configured candlesticks checking conditions. When all of the configured illustrations 216 forming the candlesticks checking conditions are all fulfilled, then a situation of satisfying the configured securities suggesting conditions is formed. Namely, for a security, if any portion of its historical or intraday candlesticks chart during a specific time duration satisfies overall the user-configured candlesticks checking conditions formulated by one or more user-configured illustrations 216, then the user device 20 would issue a corresponding alarm signal.

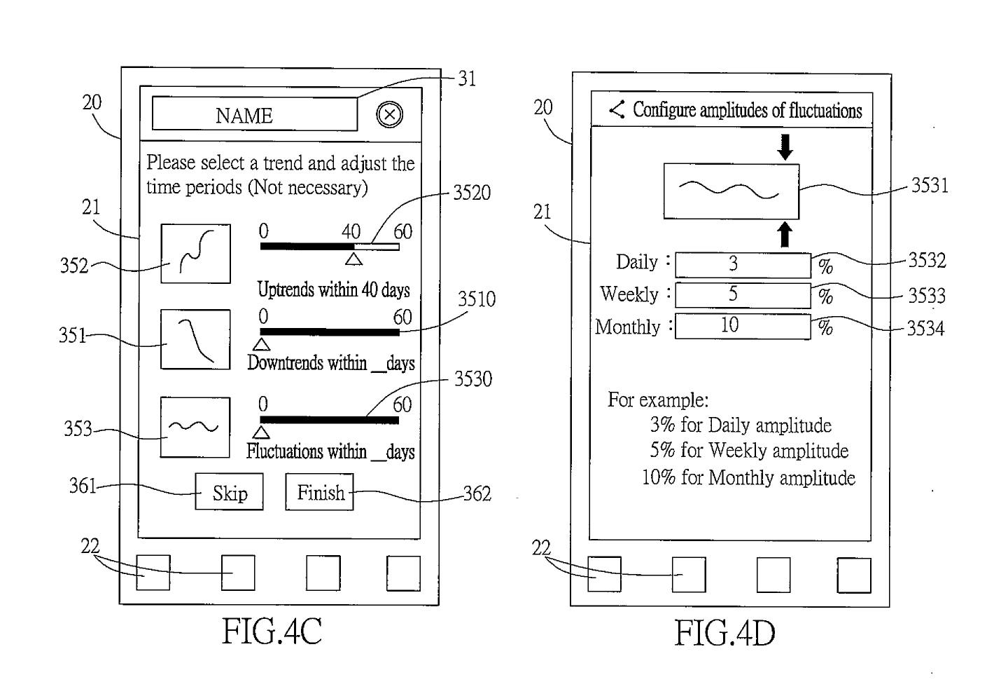

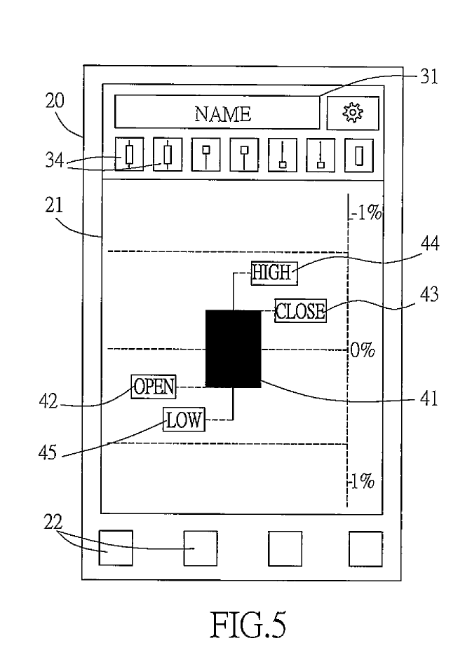

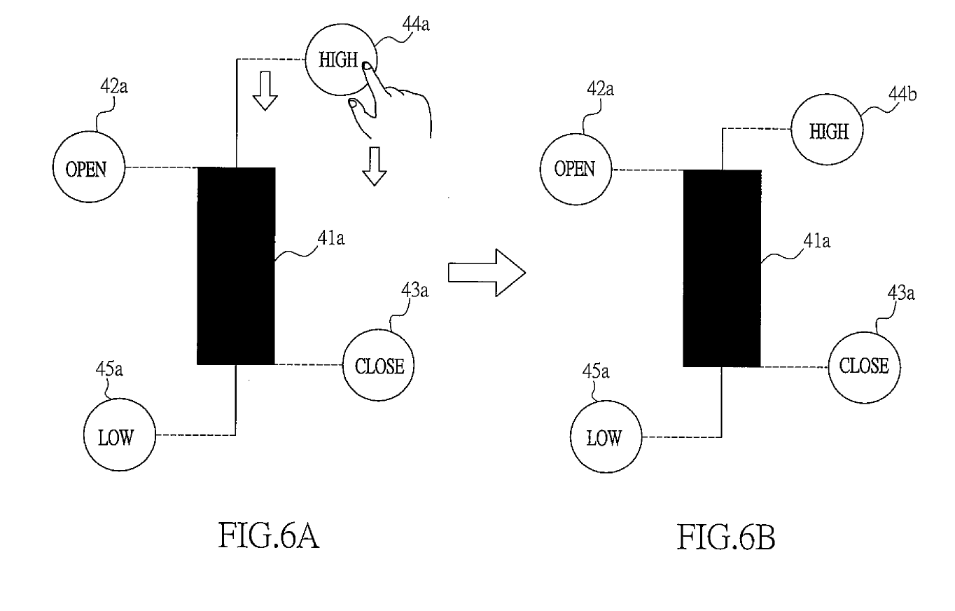

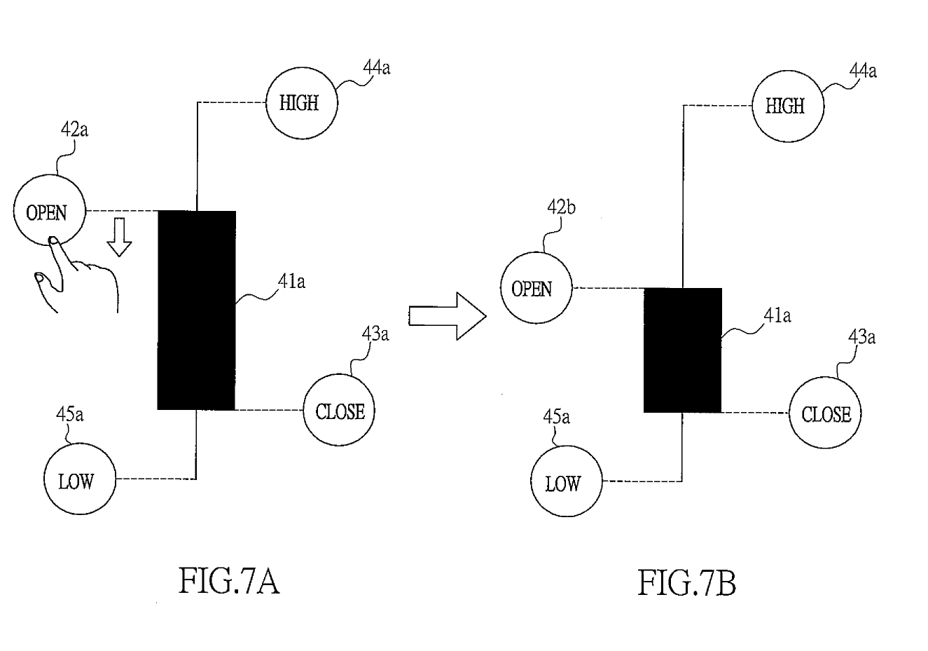

Step (A2): Referring now to FIG. 4A, FIG. 4B, FIG. 4C and FIG. 4D, schematical views for a “My pattern” suggesting window, plural candlesticks, plural candlestick charts, and a configutation window of the configured security on the user device 20 of the securities information processing system in accordance with the present invention are shown, respectively. Under the manipulation related to FIG. 3, as the user clicks a specific configured illustration 216, a page resembled to that shown in FIG. 4A would appear on the touch screen 21 of the user device 20. At this time, the displaying of the securities suggesting setting function on the touch screen 21 can include a name block 31 for the user to enter a configured name for the selected configured illustration 216, a “My pattern” suggesting window 311, a functional block 312 located in the suggesting window 311, and a virtual confirmation button 313. In the suggesting window 311, suggesting words for leading the user to operate the instant function are listed, such as “Please begin to edit at least one candlestick from right to left.” In the case that the user does not need these suggesting words, he/she needs only to check the functional block 312, such that the appearance of the suggesting window 312 would be inhibited. Depressing the virtual confirmation button 313 would jump to the display in FIG. 4B.

In FIG. 4B, the page after that in FIG. 4A, the securities suggesting setting function displayed on the touch screen 21 include a name block 31 for the user to enter the configured name of the individual configured illustration 216, a plurality of neighboring initial candlesticks 32, a vertical percentage scale 33, a storage functional button 314 and a trendline-selecting functional button 315. By having TWSE as an example, the pricing limits for intraday trading is ±10%, and thus the highest scale and the lowest scale for the percentage scale 33 are +10% and −10%, respectively. FIG. 4B is a typical page for the user to configure the candles, and the method for such an operation is provided in the following Step (A3). While the user is working on or completes the configuring of the candlestick, the storage functional button 314 can be arbitrarily depressed at any time to store the configuration. By clickink the trendline-selecting functional button 315, the display as shown in FIG. 4C would be present.

As shown in FIG. 4C, as soon as any candlestick chart is entered, the securities suggesting condition configuration function would display the following on the touch screen: a name block 31 for the user to enter the configured name of the individual configured illustration 216, and a plurality of candlesticks charts 351, 352, 353 (stand for a downtrend candlestick line 351, an uptrend candlestick line 352, and a fluctuating candlesticks line 353). In addition, in the right side of each of the candlesticks lines 351, 352, 353, a corresponding period adjusting bar 3510, 3520 or 3530 is provided for the user to adjust the dates. Through depressing one of these historical candlestick charts 351, 352, 353, and then by clicking or pulling the period adjusting bar 3510, 3520 or 3530 right to the depressed candlesticks chart 351, 352 or 353, the time duration can then be setup. The corresponding candlestick sub-chart of the clicked historical candlestick chart for the configured time duration can be posted to the leftest side of the intial candlesticks 32 that would be setup by the user in a later time. After the user completes this setup, he/she needs to click the “Finish” function block 362 to store the setting upon the candlsticks chart and the time duration, and these setting would be integrated to the right side of the candlesticks of FIG. 4B. However, the aforesaid setting in the candlsticks chart and the time duration is not necessary. If the user is not interested in the historical candlesticks chart for reference3, he/she needs only to click the “Go to next step” function block 361 so as to skip this step and to enter the setup of the candlesticks of FIG. 4B.

As shown in FIG. 4C, when the user chooses one of the plurality of candlesticks charts 351, 352, 353, the displayed window would be changed to a configuration window with respect to the clicked candlestick chart. As shown in FIG. 4D, a candlestick chart 353 for a fluctuating trendline is shown. On the touch screen 21, all the parameters for user configuration upon the candlestick chart are included, such as the sample chart 3551, and percentage-input blocks 3532 (daily amplitude), 3533 (weekly amplitude), and 3534 (monthly amplitude). The user can input desired percentage amplitudes according to his/her own interests, or he/she can input the preset values of the system.

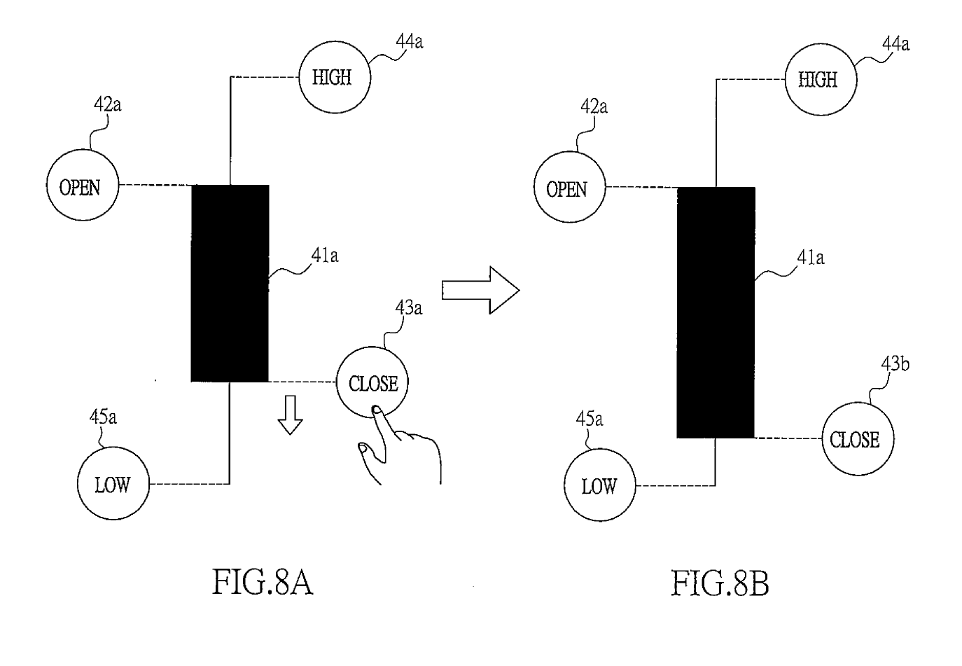

Step (A3): Referring now to FIG. 5, a schematic view of an enlarged candlestick of the configured security on the user device 20 of the securities information processing system in accordance with the present invention is shown. Under the operation environment provided by FIG. 4B, when any of the initial candlesticks 32 is clicked, the corresponding adjusting function for the clicked candlestick 32 would be immediately triggered, and thus a page similar to that shown in FIG. 5 on the touch screen 21 of the user device 20 would appear. At this time, a next-step functional button 310 and an enlarged candlestick 41 for the clicked candlestick 32 would be displayed on the touch screen 21. In addition, the enlarged candlestick 41 includes an OPEN touch point 42, a CLOSE touch point 43, a HIGH touch point 44 and a LOW touch point 45, in which the OPEN touch point 42, the CLOSE touch point 43, the HIGH touch point 44 and the LOW touch point 45 are individually referred to respective percentages.

In this embodiment, while in performing the candlestick adjusting function, the enlarged candlestick 41, the name block 31, the several setup-already mini candlesticks 34 with respective colors and sizes, and a percentage scale for illustrating the corresponding percentage values of the aforesaid four touch points 42, 43, 44, 45 of the enlarged candlestick 41 would be simultaneously displayed on the touch screen 21. While any of the mini candlesticks 34 is clicked, the color and the size of the clicked mini candlestick 34 would be then introduced to construct the enlarged candlestick 41. Thereafter, the user can adjust the color and size of the enlarged candlestick 41 according to the following Step (A4).

Step (A4): Check if a depress-and-pull operation is performed by the user on any one of the OPEN touch point, the CLOSE touch point, the HIGH touch point and the LOW touch point of the enlarged candle, adjust, if positive, the percentage corresponding to the any one of the OPEN touch point, the CLOSE touch point, the HIGH touch point and the LOW touch point of the enlarged candlestick according to the user till the depress-and-pull operation ends, then adjust further a color and a shape of the enlarged candlestick according to a result of user's depress-and-pull operation so as to form an adjusted candle, and replace the enlarged candlestick with the adjusted candlestick on the touch screen. In this embodiment, the aforesaid depress-and-pull operation is performed only by pulling up and down to change the respective percentage.

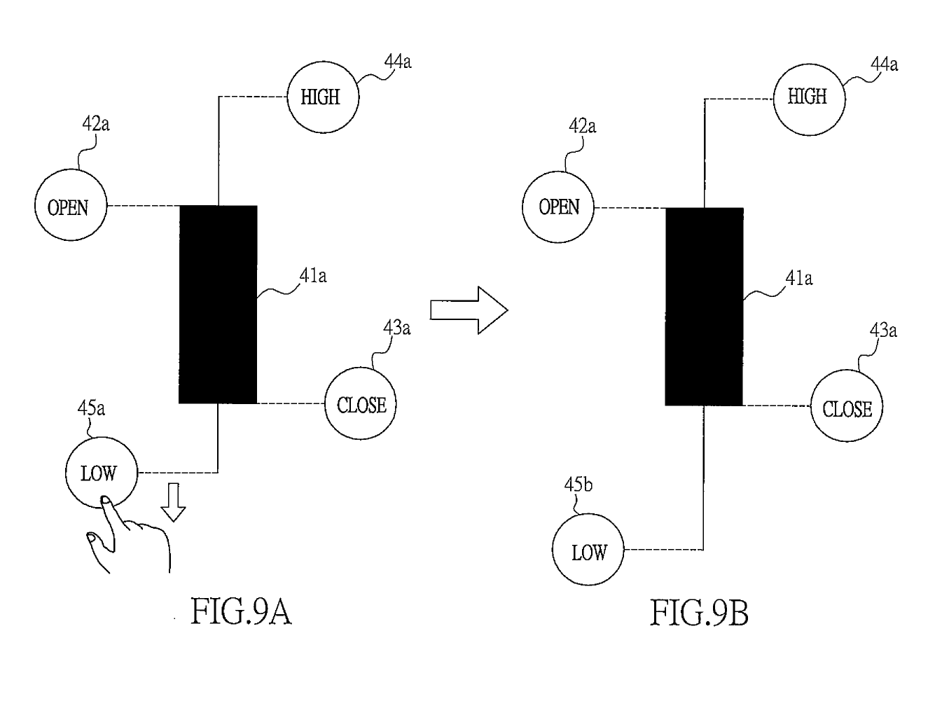

Referring now to FIG. 6A to FIG. 12B, operational states of various embodiments of the depress-and-pull operation upon a candlestick of the processing method for fuzzy checking securities information in accordance with the present invention are shown.

As shown in FIG. 6A, while the user executes the depress-and-pull operation (pulling down for example) upon the HIGH touch point 44a of the enlarged candlestick 41a on the touch screen 21, only the position of the HIGH touch point 44a can be pulled down. Hence, as shown in FIG. 6B, in the enlarged candlestick 41a, only the HIGH touch point 44b is down shifted, while the other touch points 42a, 43a, 45a and the enlarged candlestick 41a itself would keep positions (i.e. motionless).

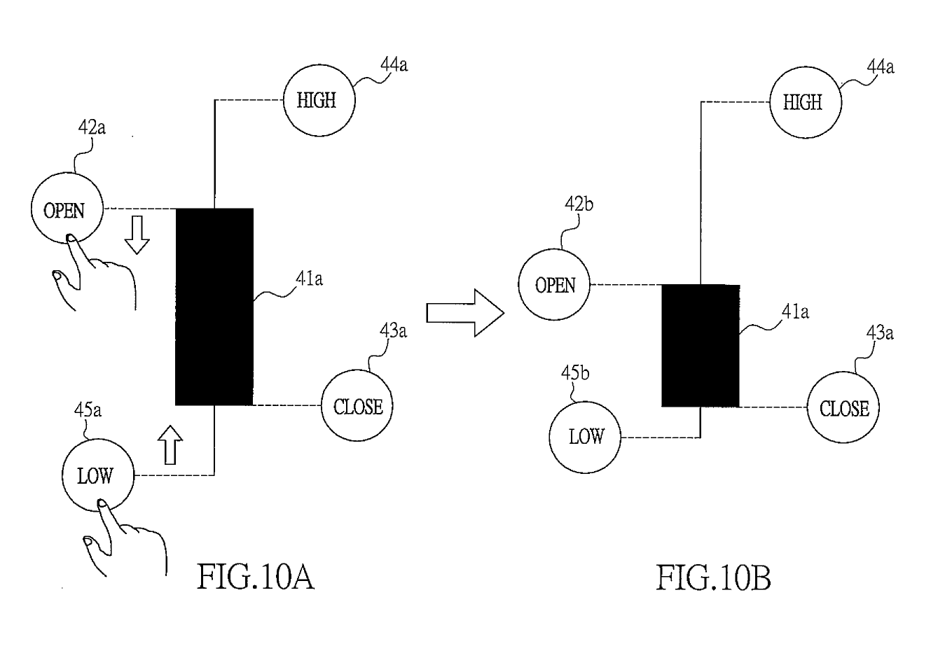

As shown in FIG. 7A, while the user executes the depress-and-pull operation (pulling down for example) upon the OPEN touch point 42a of the enlarged candlestick 41a on the touch screen 21, only the position of the OPEN touch point 42a can be pulled down. Hence, as shown in FIG. 7B, in the enlarged candlestick 41a, only the OPEN touch point 42b is down shifted, while the other touch points 43a, 44a, 45a and the enlarged candlestick 41a itself would keep positions (i.e. motionless).

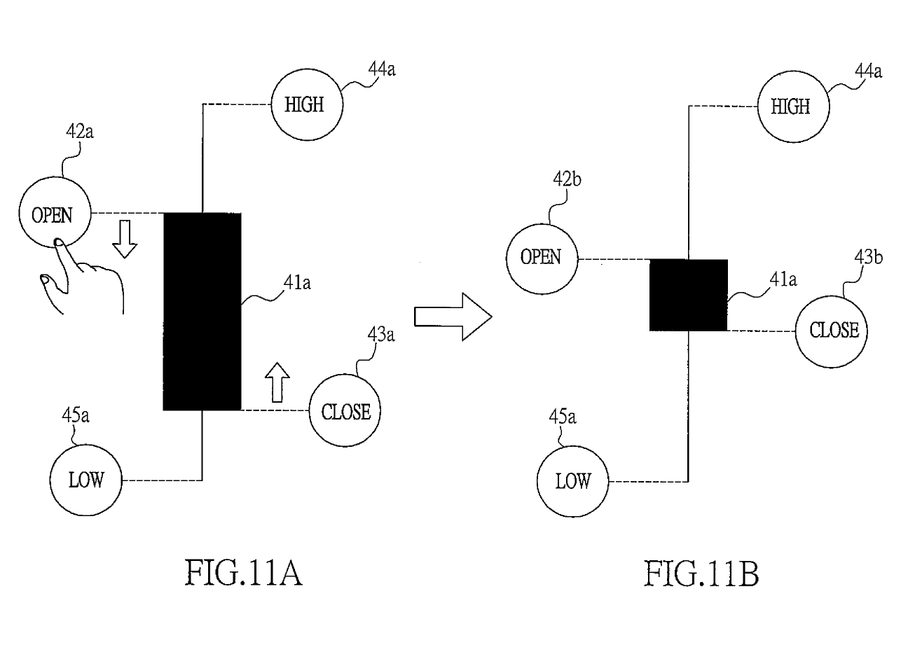

As shown in FIG. 8A, while the user executes the depress-and-pull operation (pulling down for example) upon the CLOSE touch point 43a of the enlarged candlestick 41a on the touch screen 21, only the position of the CLOSE touch point 43a can be pulled down. Hence, as shown in FIG. 8B, in the enlarged candlestick 41a, only the CLOSE touch point 43b is down shifted, while the other touch points 42a, 44a, 45a and the enlarged candlestick 41a itself would keep positions (i.e. motionless).

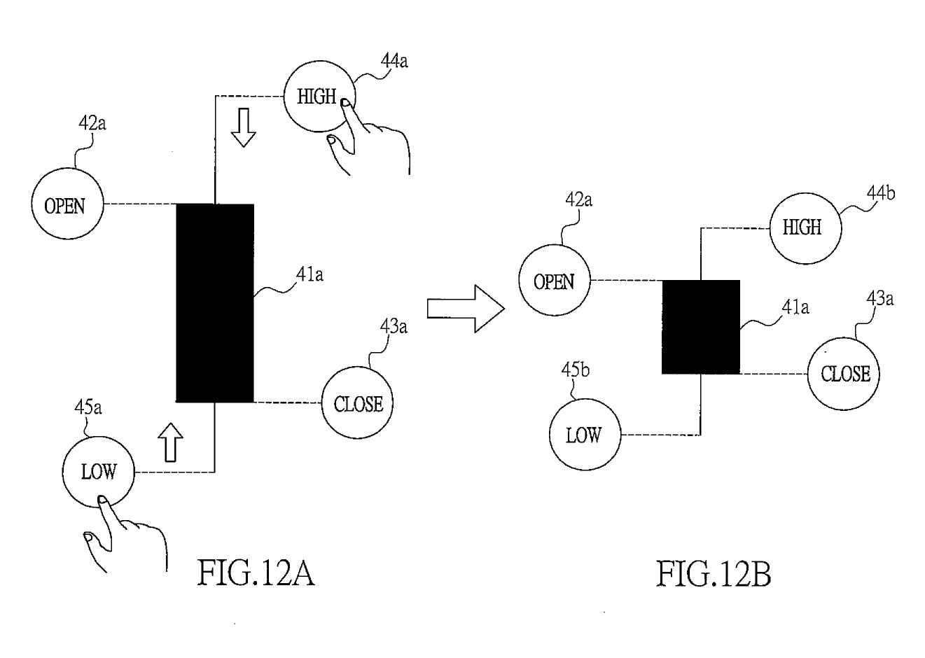

As shown in FIG. 9A, while the user executes the depress-and-pull operation (pulling down for example) upon the LOW touch point 45a of the enlarged candlestick 41a on the touch screen 21, only the position of the LOW touch point 45a can be pulled down. Hence, as shown in FIG. 9B, in the enlarged candlestick 41a, only the LOW touch point 45b is down shifted, while the other touch points 42a, 43a, 44a and the enlarged candlestick 41a itself would keep positions (i.e. motionless).

While the user executes the depress-and-pull operation upon the enlarged candlestick 41a itself on the touch screen 21, the entire enlarged candlestick 41a associated with the OPEN touch point 42, the CLOSE touch point 43, the HIGH touch point 44 and the LOW touch point 45 would be pulled together. Hence, such a movement would be limited to the up-and-down movement along the percentage scale. No left-and-right movement would be allowed.

In the aforesaid description upon the operations of the candlestick adjusting function in accordance with the present invention, only the pull-down operation upon a single position is manipulated. In other embodiments, the user can apply similar operations to pull up the touch points. Further, in the candlestick adjusting function of the present invention, two-finger operations are also allowed.

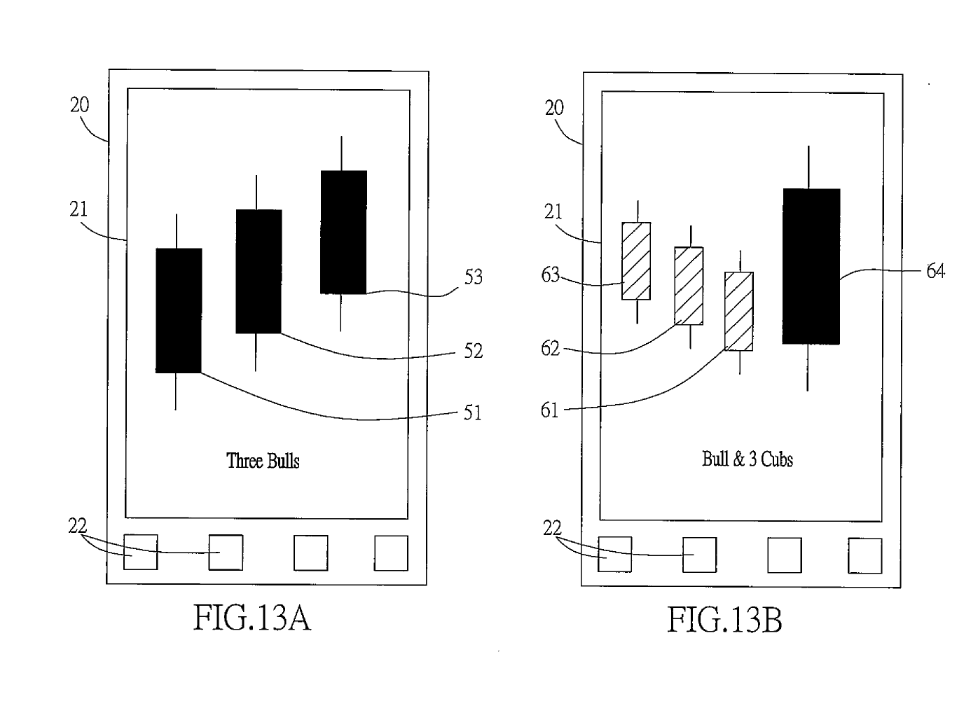

As shown in FIG. 10A, while the user uses two fingers to perform simultaneously the depress-and-pull operations upon the LOW touch point 45a and the OPEN touch point 42a of the enlarged candlestick 41a on the touch screen (for example, to pull down the OPEN touch point 42a, but to pull up the LOW touch point 45a at the same time). At this time, as shown in FIG. 10B, the OPEN touch point 42b and the LOW touch point 45b would be pulled down and up, respectively; while the other two touch points 43a, 44a and the enlarged candlestick 41a itself would be motionless.

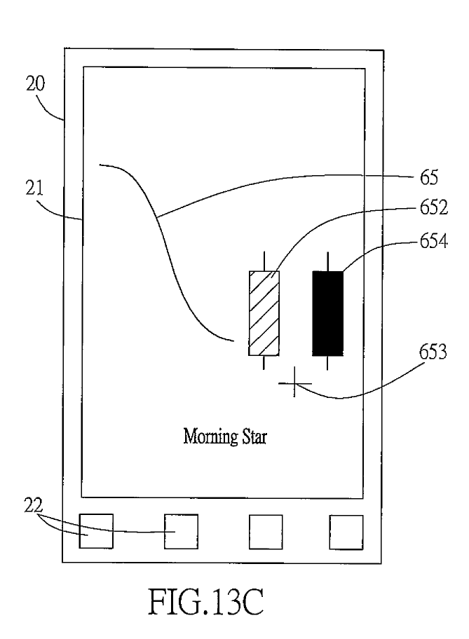

As shown in FIG. 11A, while the user uses two fingers to perform simultaneously the depress-and-pull operations upon the OPEN touch point 42a and the CLOSE touch point 43a of the enlarged candlestick 41a on the touch screen (for example, to pull down the OPEN touch point 42a, but to pull up the CLOSE touch point 43a at the same time). At this time, as shown in FIG. 11B, the OPEN touch point 42b and the CLOSE touch point 43b would be pulled down and up, respectively; while the other two touch points 44a, 45a and the enlarged candlestick 41a itself would be motionless.

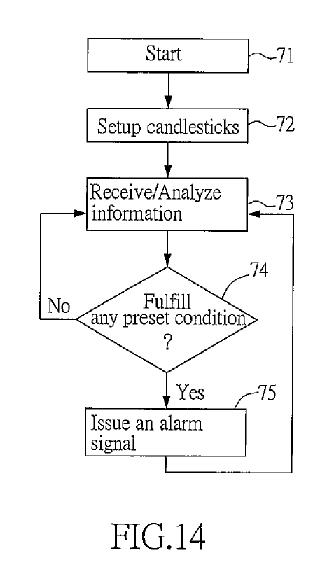

As shown in FIG. 12A, while the user uses two fingers to perform simultaneously the depress-and-pull operations upon the HIGH touch point 44a and the LOW touch point 45a of the enlarged candlestick 41a on the touch screen (for example, to pull down the HIGH touch point 44a, but to pull up the LOW touch point 45a at the same time). At this time, as shown in FIG. 12B, the OPEN touch point 42a, the CLOSE touch point 43a, the HIGH touch point 44b and the LOW touch point 45b of the enlarged candlestick 41a would be proportionally shrunk with respect to the percentage scale. On the other hand, if the user pulls up the HIGH touch point 44a, but pulls down the LOW touch point 45a at the same time, then the OPEN touch point 42a, the CLOSE touch point 43a, the HIGH touch point 44b and the LOW touch point 45b of the enlarged candlestick 41a would be proportionally enlarged with respect to the percentage scale.

In this embodiment, in the case that the OPEN touch point 42 is higher than the CLOSE touch point 43, the enlarged candlestick 41 itself would present in a first color (in Taiwan, the green color stands for a price down of the security, also called as a black candlestick). On he other hand, in the case that the OPEN touch point 42 is lower than the CLOSE touch point 43, the enlarged candlestick 41 itself would present in a second color (in Taiwan, the red color stands for a price up of the security, also called as a red candlestick). As the depress-and-pull operation performed by the user switches the positions of the OPEN touch point 42 and the CLOSE touch point 43, the color of the enlarged candlestick 41 would be changed accordingly.

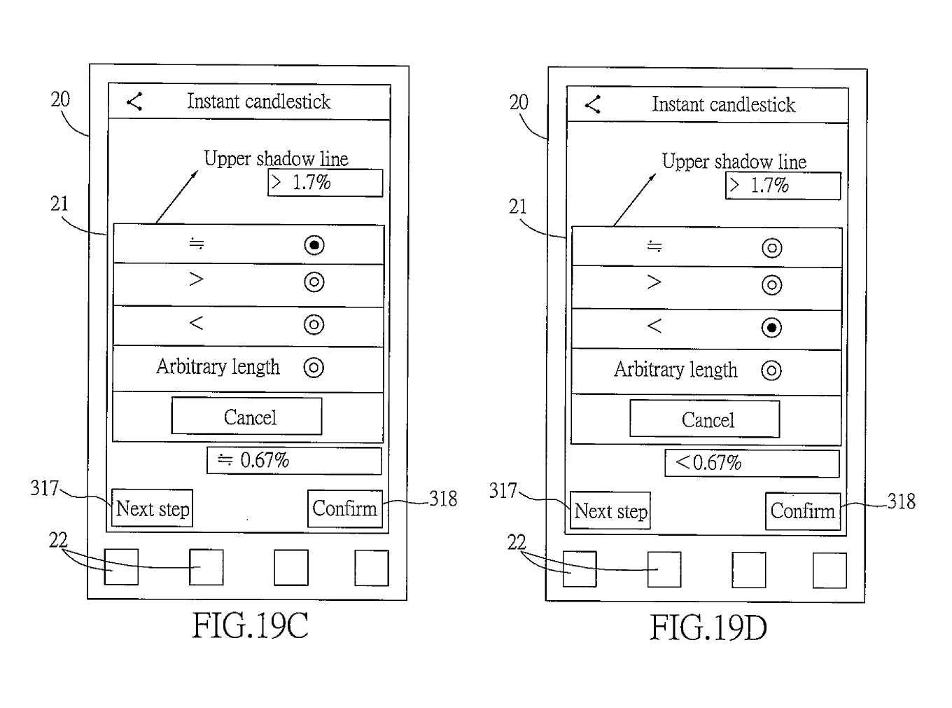

Referring now to FIG. 18, a schematic view showing an embodiment of configuring of the fuzzy checking conditions upon an enlarged candlestick of the configured security 216 on the user device 20 of the securities information processing system in accordance with the present invention is demonstrated. Posterior to the aforesaid Step (A4) and prior to the aforesaid Step (A5), a Step (A4a) is further included as follows.

As shown in FIG. 18, on the touch screen 21, the enlarged candlestick, a corresponding input block of the upper-shadow-line fuzzy checking condition 411, a corresponding input blocks of the solid-line fuzzy checking condition 412, 413, a corresponding input block of the lower-shadow-line fuzzy checking condition 414, a corresponding input block of the “Close today-yesterday” fuzzy checking condition 415, a “Previous step” functional button 317 and a “Confirm” functional button are shown. The user can click the input block of the upper-shadow-line fuzzy checking condition 411 to configure the upper-shadow-line fuzzy checking condition to be one of a value substantially equal to a percentage value, a value larger than a percentage value, a value smaller than a percentage value and an arbitrary length. The percentage value can be configured by the user. The user can click the input blocks of the solid-line fuzzy checking condition 412, 413 to configure the solid-line fuzzy checking condition to be one of a value substantially equal to a percentage value, a value larger than a percentage value, a value smaller than a percentage value and an arbitrary length. Also, the user can configure the solid line to be red or green. Here, the percentage value can be also configured by the user. The user can click the input block of the lower-shadow-line fuzzy checking condition 414 to configure the lower-shadow-line fuzzy checking condition to be one of a value substantially equal to a percentage value, a value larger than a percentage value, a value smaller than a percentage value and an arbitrary length. Similarly, the percentage value can be configured by the user. In addition, the user can click the input block of the “Close today-yesterday” fuzzy checking condition 415 to configure the “Close today-yesterday” fuzzy checking condition to one of a value substantially equal to a percentage value, a value larger than a percentage value, a value smaller than a percentage value and an arbitrary length; in which the percentage value can be configured by the user.

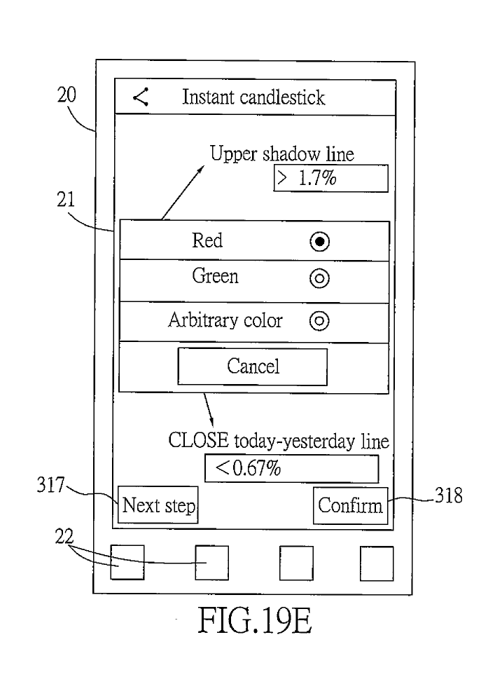

Referring now to FIG. 19A to FIG. 19E, various practical configuring embodiments for FIG. 18 are shown. In FIG. 19A, besides the user can click a desired upper-shaddow-line fuzzy checking condition to be functions of “substantially equal”, “larger than”, “smaller than’ or “an arbitrtary length”, he/she can also use the window of FIG. 18 to self configure the percentage value for the upper-shaddow-line fuzzy checking condition. After the user applies the window of FIG. 18 to click the input blocks of the solid-line fuzzy checking condition 412, 413, windows of FIG. 19B and FIG. 19E would be pulled out, respectively. In FIG. 19B, besides the user can click a desired solid-line fuzzy checking condition to be functions of “substantially equal”, “larger than”, “smaller than’ or “an arbitrtary length”, he/she can also use the window of FIG. 19E to choose the color of the solid line to be “Red”, “Green” or “arbitrary color”. After the user applies the window of FIG. 18 to click the input blocks of the lower-shadow-line fuzzy checking condition 414, the window of FIG. 19C would appear. At this time, the user can click a desired lower-shadow-line fuzzy checking condition to be functions of “substantially equal”, “larger than”, “smaller than’ or “an arbitrtary length”, and the user can also applies the window of FIG. 18 to click the input block of the lower-shadow-line fuzzy checking condition 414 to self configure the percentage value for the lower-shadow-line fuzzy checking condition. After the user clicks a desired “Close today-yesterday” fuzzy checking condition to be functions of “substantially equal”, “larger than”, “smaller than’ or “an arbitrtary length” in the input block 415, he/she can also apply FIG. 18 to self configure the percentage for the “Close today-yesterday” fuzzy checking condition; in which the “Close today-yesterday” is defined the percentage value derived by dividing the value that subtracts yesterday's CLOSE from tioday's CLOSE by yesterday's CLOSE.

Step (A5): Go back to Step (A3), and replace the clicked initial candlestick 32 on the touch screen 21 with a minimized candlestick of the adjusted candle. The user can select another initial candlestick 32 to perform the same adjusting operation. After the user completes all candle-adjustment upon the plurality of the initial candlesticks 32, then integrate the setup candlesticks charts and time periods in the Step (A2) and FIG. 4A with the respective percentages corresponding to the OPEN touch point 42, the CLOSE touch point 43, the HIGH touch point 44 and the LOW touch point 45 of each of the adjusted candlesticks 41 to update the respective candlesticks checking conditions. In addition, in these candlesticks checking conditions, the checking condition formed in the Step (A2) for the setup candlesticks charts and time periods is prior to the checking condition upon each of the adjusted candlesticks 41.

In this embodiment, the system of the present invention can adjust automatically the built-in parameters to compensate possible difference in counting the number of the configured candlesticks of Step (A3) and FIG. 4B. For example, if the user defines n candlesticks in Step (A3) and FIG. 4B, then the computation of the setup candlesticks charts and time periods by the user in Step (A2) and FIG. 4A would be as follows.

Firstly, if the clicked candlesticks chart in Step (A2) and FIG. 4A is an uptrend chart 352 and the setup time period is an x-day period, then the so-called uptrend chart shall meet the following two mathematic criteria:

(1) the maximum HIGH of the recent y days prior to the n days≧the maximum HIGH of the recent x days prior to the n days; and

(2) the minimum average of the x-day period of the recent y days prior to the n days≧the minimum average of the x-day period of the recent x days prior to the n days;

in which n, x and y are all positive integers, n is the number of the candlesticks defined by the user in Step (A3) and FIG. 4B, preferably 1≦n≦5, x and y are configured values by the user. In this embodiment, 2≦y≦5, 3≦x≦60, and y<x. In this system, the preset values available for the user are x=20 and y=5 for each of the daily candlesticks chart, the weekly candlesticks chart, and the monthly candlesticks chart. Only if the candlestick data of a specific security of the recent x-day period before the n days meet the aforesaid two criteria, the candlesticks chart of the security in the x-day period can be said to meet the uptrend chart of the present invention.

Similarly, if the clicked candlesticks chart in Step (A2) and FIG. 4A is a downtrend chart 351 and the setup time period is an x-day period, then the so-called downtrend chart or downtrend candlestick line shall meet the following two mathematic criteria:

(1) the minimum LOW of the recent y days prior to the n days≦the minimum LOW of the recent x days prior to the n days; and

(2) the maximum average of the x-day period of the recent y days prior to the n days≦the maximum average of the x-day period of the recent x days prior to the n days;

in which n, x and y are all positive integers, n is the number of the candlesticks defined by the user in Step (A3) and FIG. 4B, preferably 1≦n≦5, x and y are configured values by the user. In this embodiment, 2≦y≦5, 3≦x≦60, and y<x. In this system, the preset values available for the user are x=20 and y=5 for each of the daily candlesticks chart, the weekly candlesticks chart, and the monthly candlesticks chart. Only if the candlestick data of a specific security of the recent x-day period before the n days meet the aforesaid two criteria, the candlesticks chart of the security in the x-day period can be said to meet the downtrend chart of the present invention.

Further, if the clicked candlesticks chart in Step (A2) and FIG. 4A is a fluctuating chart 353 and the setup time period is an x-day period, then the so-called fluctuating chart or fluctuating candlestick line shall meet the following mathematic criterion:

(the maximum average of the y-day period of the recent x days prior to the n days/the minimum average of the y-day period of the recent x days prior to the n days)≦z;

in which n, x and y are all positive integers, n is the number of the candlesticks defined by the user in Step (A3) and FIG. 4B, preferably 1≦n≦5, x and y are configured values by the user. In this embodiment, 2≦y≦5, 3≦x≦60, and y<x. The z is positive configured by the user, and preferably 1.01≦z≦1.10. In this system, the preset values available for the user are x=20, y=5 and z=1.03 for the daily candlesticks chart; x=20, y=5 and z=1.05 for the weekly candlesticks chart; and x=20, y=5 and z=1.10 for the monthly candlesticks chart. Only if the candlestick data of a specific security of the recent x-day period before the n days meet the aforesaid criterion, the candlesticks chart of the security in the x-day period can be said to meet the fluctuating chart of the present invention.

In another embodiment, except for these three x, y, z values can be configured by the user or can adopt the preset values, a hybrid application can also be adopted; for example, to apply the user-configuring x, y values and a z value provided by the system according to the given x, y values. Generally, if the user assigns bigger values to x and y, then a bigger z value would be provided by the system.

In the foregoing description, the application of the present invention can adopt, but shall not be limited to, the aforesaid system preset values or ranges.

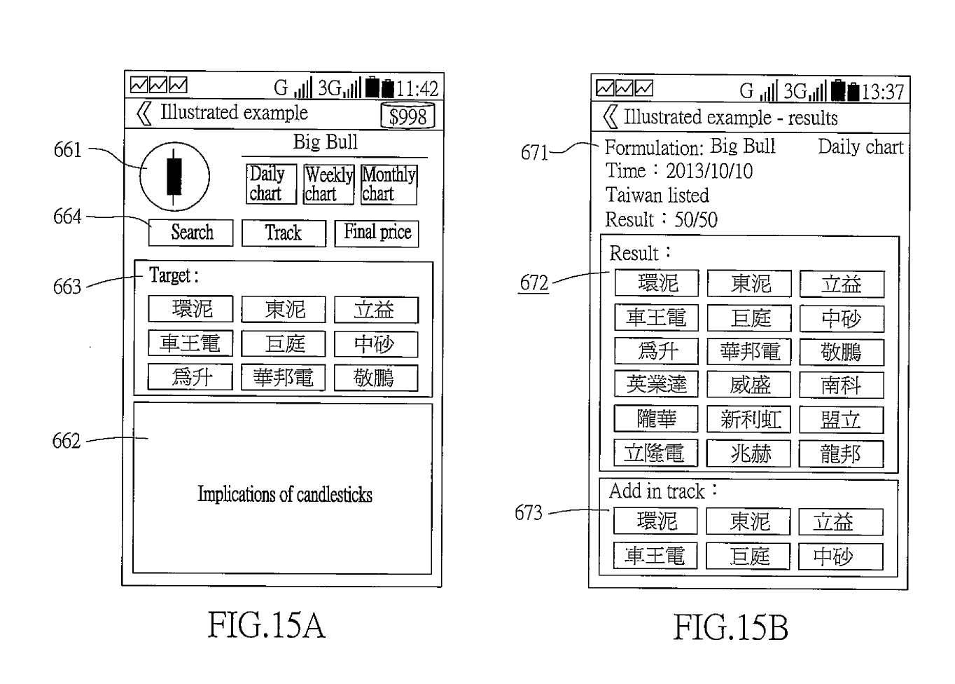

Referring now to FIG. 13A, FIG. 13B and FIG. 13C, three of various arrangements of three preset or configured candlesticks of the processing method for fuzzy checking securities information in accordance with the present invention are shown, respectively. In the case that some candlesticks 41 contained in one of the preset candlestick formulations 214 or the configured illustrations 216 are similar to the three consecutive green (uptrend) candlesticks 51, 52, 53 of FIG. 13A and the CLOSE and HIGH positions of these three candlesticks are going higher and higher, it says that this specific security during this predetermined 3-day time period is in an uptrend. Hence, any security fulfilling this securities suggesting condition would be strong and in the uptrend in a short-term future. Therefore, the user of the user device 20 shall stand by the long or buy side of this security.

On the other hand, if some candlesticks 41 contained in one of the preset candlestick formulations 214 or the configured illustrations 216 are similar to the three small consecutive red (downtrend) candlesticks 63, 62, 61 and a last bigger green candlestick 64 of FIG. 13B and the CLOSE and HIGH positions of the green candlestick 64 are higher than any CLOSE or HIGH position of the three red candlesticks 63, 62, 61, it says that, during this predetermined 4-day time period, this specific security begins now a strong uptrend, bouncing from a three-day downtrend. Hence, any security fulfilling this securities suggesting condition would have a possibility of bouncing back to an uptrend. Therefore, the user of the user device 20 shall stand by the long or buy side of this security.

Furthermore, if some candlesticks 41 contained in one of the preset candlestick formulations 214 or the configured illustrations 216 are similar to the trend shown in FIG. 13C where, after a downtrend candlestick line 65, a red candlestick 652, a cross candlestick 653 and a green candlestick 654 follow in order, and the price-up of the last geen candlestick 654 has compensated the price-down of the red candlestick 652, then it says that, for this security, though in a long-term downtrend, the downtrend seems to meet a bottom, a strong bouncing back seems to be around the corner, and a term of uptrend can be forseen. Therefore, the user of the user device 20 shall stand by the long or buy side of this security.

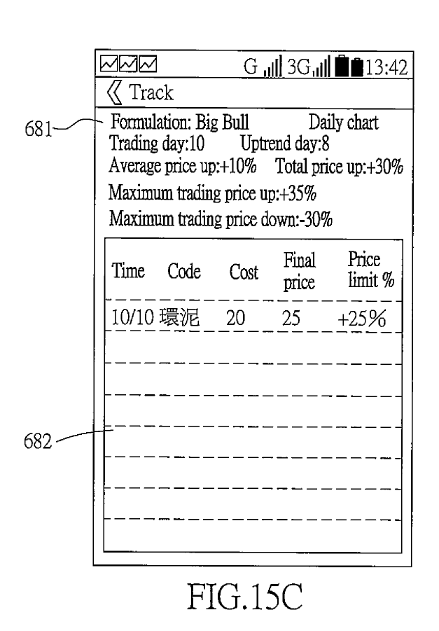

Referring now to FIG. 14, a flowchart of applying a first embodiment of the processing method for fuzzy checking securities information in accordance with the present invention to a user device in a securities information processing system is shown. In this embodiment, either the user-configuring or the preset securities suggesting conditions can be used to sort the candidate securities. The method includes the following steps.

Step 71: Start to perform the first embodiment of the processing method for fuzzy checking securities information in accordance with the present invention in the user device.

Step 72: Setup the candlesticks, according to the aforesaid Step (A1) through Step (A5) to configure the candlesticks checking conditions and the securities suggesting conditions. In another embodiment, the securities suggesting conditions built-in the user device can also be the alternatives for the configured conditions.

Step 73: Receive and analyze the information. The user device utilizes the communicative media 14 to capture at least one trading and/or statistics data of at least one security (the information of the securities thereafter) from the server 11 or the information source 13 of the securities information service system 10 and further to analyze the information of the securities.

Step 74: Check if the information of the securities meets any one of the preset conditions? Namely, by introducing the aforesaid Step (B) to examine if any one of the information of the securities fulfills any one of the securities suggesting conditions? If “yes” or positive, perform Step 75. Otherwise, go back to Step 73.

Step 75: The user device 20 issues an alarm signal, and displays on the touch screen the name or code of the securities that meet the securities suggesting conditions. In addition, a word, a symbol, a sound or a flash corresponding to the alarm signal can also be selectively posted to the touch screen, so as to have the user's attention to be aware of the securities, as well as related detail information, that meet the securities suggesting condition.

As shown in FIG. 14, in the first embodiment, the user device is firstly to retrieve or download the trading and/or statistics data of the securities from the foreign server 11 or information source 13. Then, in the user device, the received information of the securities is checked to see if any one of the preset conditions is satisfied. However, in another embodiment, the user device can also forward the selected securities suggesting conditions, whether the configured or the preset, in Step 72 to the server of the securities information processing system. In the server, the trading and/or statistics data of the securities captured from the foreign information source can be stored. Also, the server can check and analyze, in a cloud manner, if any of the trading information of the securities fulfills any one of the securities suggesting conditions. Then, the results of checking and analyzing, including the satisfied information of the securities, are forwarded to the user device. Namely, in this embodiment, the user device bases on the selected securities suggesting conditions to formulate a search request and further to forward this search request to the sever. Then, all other checking and analyzing are carried at the server end, while the user device is only there to receive the send-back search result from the server.

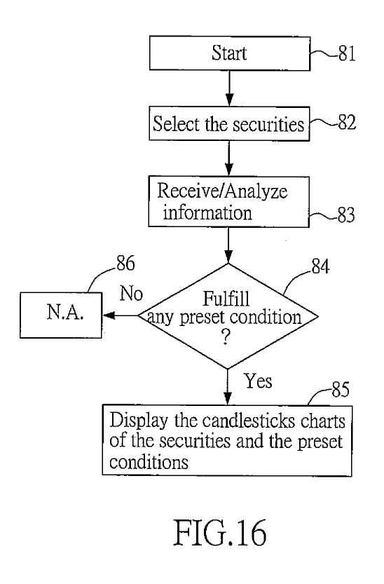

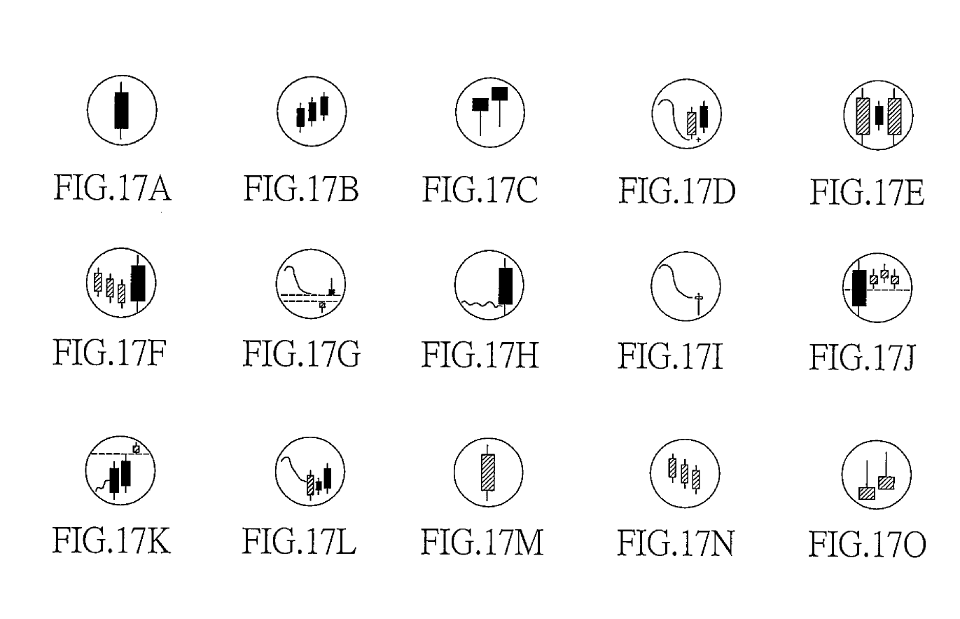

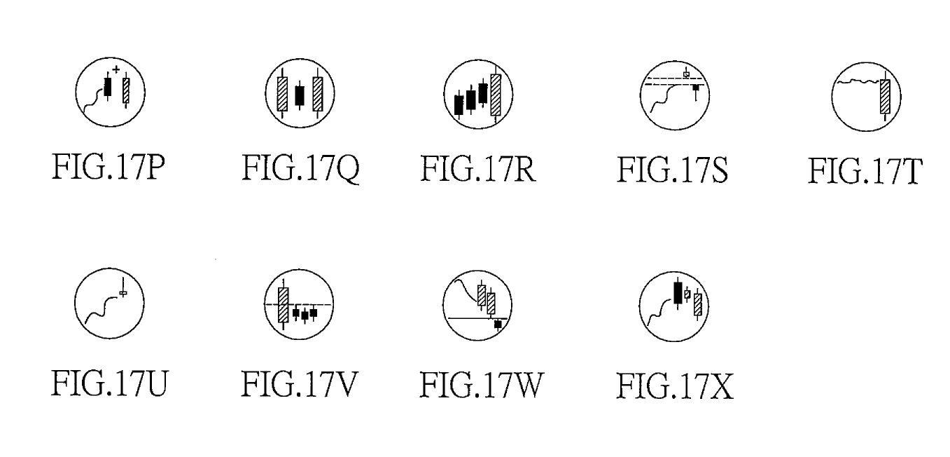

According to the aforesaid Step 71 to Step 75 of the processing method for fuzzy checking securities information, the candlesticks checking conditions and the securities suggesting conditions can be configured, or can be the securities suggesting conditions built-in the user device, to check and analyze if the trading information of the securities fulfills any one of the preset conditions. If the answer is positive, the names or codes of the securities that meet the securities suggesting conditions would be displayed on the touch screen 21 of the user device 20. For example, FIG. 15A shows a touch screen of a user device with built-in preset securities suggesting conditions for the processing method for fuzzy checking securities information in accordance with the present invention. In the case that the user clicks one of the peset illustrations of the preset securities suggesting conditions built in the user device as shown in FIG. 2, then the touch screen 21 of the user device 20 would display a page similar to that shown in FIG. 15A, which includes on this touch screen the preset illustration 661 of the selected securities suggesting conditions, the name block for the preset illustration (for example, the Big Bull), the implication block 662 of the preset illustration, name or code block 663 of the configured securities, and a plurality of functional blocks 664. As shown, these functional blocks 664 may include a search button, a track button, a final-sale button, a daily line button, a weekly line button, and a monthly line button. By clicking the search button, the user device begins to search according to the securities suggesting conditions in correspondence with the preset illustration 661 shown on this page, and displays all the search results (securities that meet the search conditions) in the name or code block 663.

As shown in FIG. 15B, another screen of FIG. 15A is present, on which specific securities meeting the securities suggesting conditions are displayed. In this page, the touch screen of the user device demonstrates basic search conditions in an information illustration block 671, and the securities list for those meeting the search conditions in the result illustration block 672. Also, a track illustration block 673 for listing the favored securities is included. The user can select a plurality of securities as the securities for tracking from the result illustration block 672, and the securities for tracking are listed in the track illustration block 673. Upon such an arrangement, after a substantial period of time (for example, 10 days of trading, a month or a season), the user may perform a check-tracking function to see the price variation of the securities for tracking since the date of meeting the securities suggesting conditions. Further, on the page of FIG. 15B, if the user interests in the real-time price, technical analysis, basic information, sharing information, individual news and the like information of any one of the securities in the result illustration block 672 or the track illustration block 673, then he/she needs only to click at the target securities so as to obtain immediately the aforesaid information. Thereby, the user can peform an in-depth research at the favored securities before organizing his/her strategy for trading of the securities.

As shown in FIG. 15C, a further screen of FIG. 15A is present, on which details of securities to be tracked are displayed. In FIG. 15C, the illustration block 681 displays the basic information of the selected securities suggesting conditions, the price variation of the securities for tracking since the date of meeting the securities suggesting conditions; for example, but not limited to, the up-to-date loss and gain information since the date of meeting the securities suggesting conditions up to the current date, including the dates, the stocks, the prices, HIGHs and LOWs, profit ratios and so on. In addition, if the user stores the trading records of the tracked securities bought at a specific time into the user device, the method of the present invention can also compute the buying prices of the securities, the corresponding final CLOSEs, and the corresponding price fluctuation limits and can further display these information in the illustration block 682.

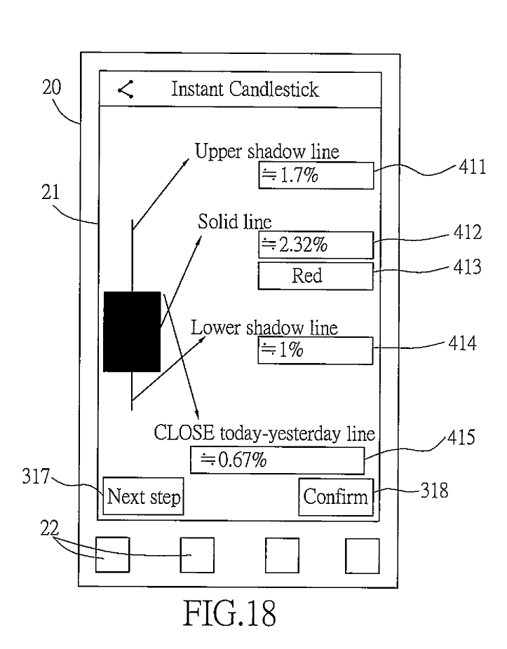

The processing method for fuzzy checking securities information of the present invention can base on the user-selected securities suggesting conditions to request a listing of qualified securities and further to track these securities. In another embodiment, the processing method for fuzzy checking securities information of the present invention can allow the user to select single or plural securities and to initiate a chart-readizing process to check if the historical candlesticks information of the securities fulfills any one of the securities suggesting conditions. As shown in FIG. 16, a flowchart of applying a second embodiment of the processing method for fuzzy checking securities information in accordance with the present invention to a user device in a securities information processing system is shown. The user is allowed to select a specific security and further to check if the historical candlesticks information of the securities fulfills any one of the securities suggesting conditions. This method can include the following steps.

Step 81: Start to perform the second embodiment of the processing method for fuzzy checking securities information in the user device, in which the user device stores a plurality of built-in or user-configured securities suggesting conditions.

Step 82: Select the securities, where the user can manupilate the user device to select name or code of a security to be checked.

Step 83: Receive and analyze the information. The user device utilizes the communicative media 14 to capture and further analyze the historical trading information of the security including the historical candlesticks information from the server 11 or the information source 13 of the securities information service system 10.

Step 84: Check and analyze if the historical trading information of the security including the historical candlesticks information fulfills any one of prese conditions. Namely, Check and analyze if the historical candlesticks information of the securities includes any one of securities suggesting conditions built in the user device or configured by the user. If the result is positive a “YES”, then perform Step 85. Otherwise, perform Step 86.

Step 85: Display the historical candlesticks chart of the securities, and post the fulfilled securities suggesting condition of Step 84 into the historical candlesticks chart so as to have the user conveniently to look and realize. With the help of the historical candlesticks chart of the securities associated with the fulfilled securities suggesting conditions, the determination of the timing and pricing for buying and/or selling the specific the securities would be much easily.

Step 86: Display only the historical candlesticks chart of the securities and the words of “No fulfilled condition!”

In the second embodiment of the processing method for fuzzy checking securities information of the present invention as shown in FIG. 16, the user device is to firstly capture the trading information or statictic data of the securities from a foreign server 11 or information source 13, and then the user device performs the checking of these captured trading information or statictic data of the securities to see if any of them fulfills a preset condition. In a further embodiment of the present invention, the user device can forward names and/or codes of the selected securities of Step 82 by the user to the server of the securities information processing system, in which the server stores a plurality of securities suggesting condition as well as the trading information or statictic data of the securities captured from the information source 13. Then, the server can check and analyze, in a cloud manner, if the security or securities fulfill any one of the securities suggesting condition. Then, the checked result including the data of the fulfilled securities and the related securities suggesting conditions is forwarded to the user device. Namely, in this embodiment, the user device can only base on names or codes of user's selected securities to generate a search request to be forwarded to the server. All the checking, analysis and calculations are all performed in the server end, while the user device end can only receive the search result from the server.

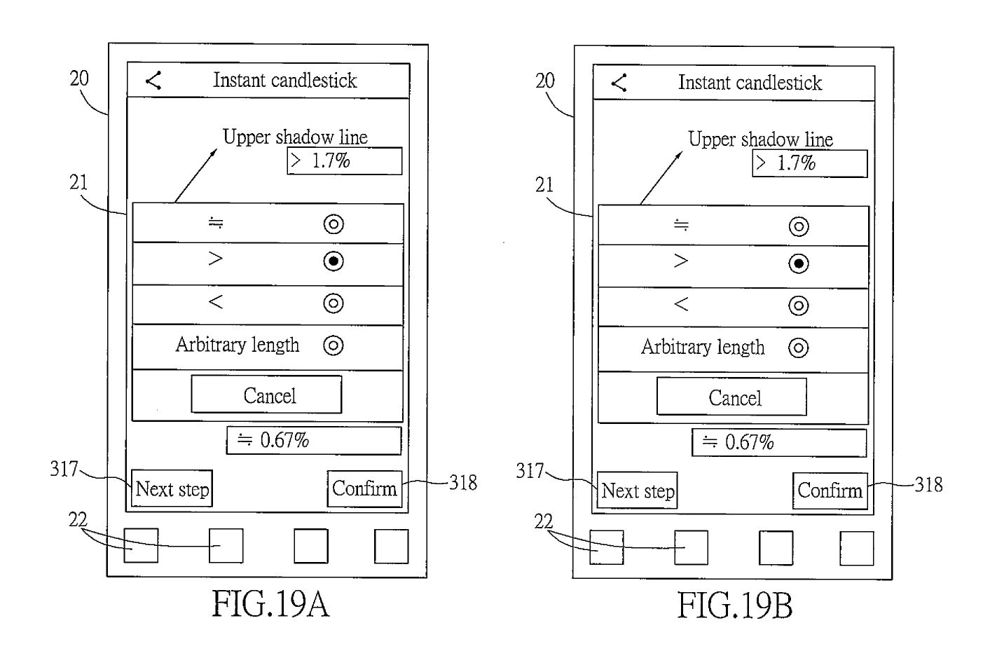

As described above, the processing method for fuzzy checking securities information of the present invention utilizes the preset candlestick formulations 214 shown in FIG. 2 to form the corresponding candlesticks checking conditions. Such an arrangement can facilitate the user to straightforwardly configure the desired searching or tracking securities suggesting conditions. All these preset candlestick formulations 214 including different combinations of the candlesticks may implicate respective trends for trading of the securities, and also provide the user an important reference for predicting the trend of his/her favored securities. Referring now to FIG. 17A through FIG. 17X, various typical preset candlestick formulations 214 are illustrated and details to elucidate the individual definitions, implications and corresponding reminders are listed below.

(A) Long Candidates

As shown in FIG. 17A, a “Big Bull” is shown.

Definition: The candlestick has a large green body. The price goes up after the market's OPEN, and the CLOSE is much higher than the OPEN. Personal own size can be defined in a DIY pattern.

Implication: The intraday buying power is much stronger than the selling power. If the OPEN is lower than yesterday's CLOSE, the Big Bull indicates the price is acceptable to many at this level. If the OPEN is higher than the previous CLOSE, the Big Bull indicates a strong buy. If the Big Bull is in a long downtrend, it might be the beginning of a bottom. If a high volume is accompanied with the Big Bull, the possibility for the beginning of a bottom is high. This would be considered as a bottoming signal or a going-up signal, namely a good time to buy.

Reminder: If the Big Bull is in a long uptrend with a decreasing volume, it might be a sign of topping. Watch out for subsequent development. You might want to sell or even to short.

As shown in FIG. 17B, a “Three Bulls” is shown.

Definition: The “Three Bulls” is defined to three consecutive green candles, with each HIGH higher than the previous HIGH, and each LOW also higher than the previous LOW.

Implication: This is often a strong attack signal from the buy side in the uptrend. If it happens after a long flat-trend, it is a good sign to buy. If it happens after a long downtrend, the buying signal is even stronger, and could be a bottoming sign. If it happens after a Morning Star, there is a high probability that a bottom has formed.

Reminder: See if the volume goes up as well. Watch out for a small cap or light traffic stocks, they could be manipulated. If the Three Bulls has already pushed the price too high, then there may not be a margin left. If the Three Bulls happens after a long uptrend, it may be the last run. Watch for subsequent development.

As shown in FIG. 17C, a “Long Horns” is shown.

Definition: The “Long Horns” is defined for a situation of two consecutive days having long lower shadows, the CLOSE being at or near the HIGH and higher than the OPEN, and today's CLOSE being higher than yesterday's CLOSE. It is like two horns pointing down and ready to hook.

Implication: A long lower shadow means the CLOSE is much higher than the LOW. A Long Horn or Hammer means that the price was driven down during the day to the LOW, but brought back up much higher, and the CLOSE is at the HIGH. Two long horns with one bigger than the other indicate a strong support at this price level. If it happens in a long downtrend with a high volume, it could be a strong sign of bottoming.

Reminder: Watch the intraday volume. If the volume increases when the price goes up, then it is a strong buy. If the volume appears at the LOW, then it is not a sharp horn.

As shown in FIG. 17D, a “Morning Star” is shown.

Definition: In the downtrend, the price was driven down further by a red candlestick followed by a gap down and ended with a cross, but then jumped back up high with a long green candle, and the green candle's CLOSE is higher than the red candle's OPEN.

Implication: A cross happens when someone sells it to a LOW and others buy it to a HIGH but the CLOSE is equal to the OPEN. It means the market is active but unsure which way to go. The movement of the next day often provides the clue for the direction. Morning Star appears in a downtrend. If the downtrend is persistent, it is often a good sign of bottoming.

Reminder: The Morning Star does not happen often. When it does, it is often a good signal to buy. But do not put all your money on one sign, and watch out for fake break through. You might want to increase your long position, if it is followed by the Big Bull or the Three Bulls.

As shown in FIG. 17E, a “Bull Hug” is shown.

Definition: One small red candlestick is hugged by two green candlesticks with larger bodies. The HIGH and the LOW of the red candlestick are within the bodies of the two green candles.

Implication: It happens when some buying parties try to shake the followers by faking a down turn, but quickly pushed back up by the market. It may also happen when people are still bearish, but the buying power is strong. It often indicates the uptrend is strong.

Reminder: Watch if heavy weight buyers start to sell in the uptrend.

As shown in FIG. 17F, a “Bull & 3 Cubs” is shown.

Definition: One big bull beats three bear cubs. After three days of decline, the OPEN is low again, but then the price rises strongly to a HIGH, and the CLOSE is higher than the HIGH-est of the three red candles.

Implication: The buying power regains control and turns the trend upward, especially when the volume of the big green is about the sum of the three reds.

Reminder: If the volume is not big enough, it could be just a technical bounce. That means the fundamental of the company or sentiment of the market has not changed, the bounce back is just from the falling of the price, like a deflated ball bouncing back when falling from a high place, and is most likely to fall again.

As shown in FIG. 17G, a “Bull island” is shown.

Definition: In the downtrend, a gap down followed by a gap up. It is like a bull island in the bear sea.

Implication: The gap is often caused by certain news after previous session is closed, or driven by heavy weight buyers or sellers to the direction they want. A bull gap is a gap up and a green candle, with today's LOW higher than yesterday's HIGH. A bear gap is a gap down and a red candle, with today's HIGH lower than yesterday's LOW. A bear gap followed immediately by a bull gap is a strong reversal signal. It is often followed by at least a brief uptrend. As long as the price does not go back below the bull gap, you can consider staying on the buy side.

Reminder: Though unlikely, if the price drops back below the bull gap, it may be time to sell.

As shown in FIG. 17H, a “Break Through” is shown.

Definition: A big bull appears after a long flat-trend.

Implication: It indicates the selling pressure has been digested. It may be the beginning of a bullish run. It is time to consider a long position.

Reminder: Watch subsequent development carefully. It may be a fake break through with just one big bull. A fake signal is when it falls back down quickly and back to or below the LOW of the big bull.

As shown in FIG. 17I, a “Long Shadow Bottom” is shown.

Definition: A long lower shadow is in the downtrend. The OPEN is lower than yesterday's CLOSE, and the price keeps going down to the lowest LOW on the current downtrend, but the price goes up sharply and has the CLOSE at or near the OPEN.

Implication: It could be followed by a technical bounce with just one long lower-shadow. If it is followed by another long lower shadow and forming a long horns, then it becomes a strong sign of a bottom.

Reminder: If the volume is not substantiated, the bounce will be limited.

As shown in FIG. 17J, a “Bull Brewing” is shown.

Definition: A big bull follows by three small rises or falls, but none of the three days' LOWs falls below the mid-point of the big bull.

Implication: It indicates the resting of the buy side, but the bull may be ready to attack again. If the volume reduced during the three-day rest, the following attack may be stronger.

Reminder: If there are high volumes in the three days, then the direction is not as certain.

As shown in FIG. 17K, a “Cub Stand Up” is shown.

Definition: A gap up in the uptrend, the OPEN with a gap up but the CLOSE lower than the OPEN, and the body of the red candlestick is smaller than the bodies of the previous two green candles. It is like a small cub stands up to fight.

Implication: It is too weak to be a reversal sign. It often happens when some buyers are taking profits. If the volume is low, the cub cannot reverse the trend, and the uptrend continues.

Reminder: If the volume is high, even though the price change is small, then there are many profit-taking at this level, and the uptrend may not hold.

As shown in FIG. 17L, a “Bull Escape” is shown.

Definition: A large red candlestick hits a recent low in a downtrend, but is followed by two green candles, one smaller than the other, the larger green candlestick tops the large red candlestick with its CLOSE higher than the HIGH of the red candle.

Implication: It indicates the downward pressure has been stopped, and the buy side has the upper hand. The stopping sign is valid if the volume is high. If the volume is very high, it could be a reversal sign.

Reminder: It may not be a solid sign if the volume of any green is smaller than that of the red.

(B) Short Candidates

As shown in FIG. 17M, a “Big Bear” is shown.

Definition: The candlestick has a large red body. The price goes down after the OPEN, and the CLOSE is much lower than the OPEN. You can define your own size in a DIY Pattern.

Implication: The intraday selling power is much stronger than the buying power. If the OPEN is higher than yesterday's CLOSE, the Big Bear indicates the buy side starts profit-taking or is losing confidence. If the OPEN is lower than yesterday's CLOSE, the Big Bear indicates a strong sell. If the Big Bear happens in a long uptrend with a high volume, it might be a top forming. It could be a good time to sell, or a time to short.

Reminder: If the Big Bear happens in a long downtrend with a reduced volume, it might be the sign of a bottom. Watch out for subsequent development. You might want to establish a long position.

As shown in FIG. 17N, a “Three Bear” is shown.

Definition: Three consecutive red candles, with each LOW lower than the previous LOW, and each HIGH also lower than the previous HIGH.

Implication: This is often a strong attack signal from the sell side in the downtrend. If it happens after a long flat-trend, it is a good sign to sell. If it happens after a long uptrend, the selling signal is even stronger, and could be a top sign. If it happens after an Evening Star, it often confirms a top has formed.

Reminder: Watch out for a technical bounce. That means the fundamental of the company or sentiment of the market has not changed, the bounce back is just from the falling of the price like a deflated ball bouncing back when falling from a high place, and is most likely to fall again.

As shown in FIG. 17O, a “Bear Teeth” is shown.

Definition: Two consecutive days have long upper shadows, each with the CLOSE at or near the LOW and being lower than the OPEN, and today's CLOSE is lower than the yesterday's CLOSE. It is like a bear roaring with two teeth pointing up.

Implication: A long upper shadow means the CLOSE is much lower than the HIGH. A Tooth or Inverted Hammer means the price was driven up during the day to a HIGH, but brought back down much lower, and the CLOSE was at the LOW. Two teeth with one bigger than the other indicate a strong selling pressure at this price level. If it happens in a long uptrend and comes with a high volume, it could be a strong sign of topping.

Reminder: If there is a technical bounce in the subsequent development, but the bounce fails to reach the HIGH of the teeth, then it could be a confirmation of a top.

As shown in FIG. 17P, an “Evening Star” is shown.

Definition: In the uptrend, the price was driven up further by a green candle, followed by a gap up ended with a cross, but then jumped back down low with a long red candle, in which the red candle's CLOSE is lower than the green candle's OPEN.

Implication: A cross happens when someone sells it to a LOW and others buy it to a HIGH but the CLOSE is also equal at the OPEN. It means the market is active but unsure which way to go. The movement of the next day often provides the clue for the direction. Evening Star appears in an uptrend. If the uptrend is persistent, it is often a good sign of topping.

Reminder: Evening Star does not happen often. When it does, it is often a good sign to sell. But if you want to short, better look for more confirmations like the Big Bear or the Three Bears in the following development. Do not put all your money on a single sign.

As shown in FIG. 17Q, a “Bear Hug” is shown.

Definition: One small green candlestick is hugged by two red candlesticks with larger bodies. The HIGH and LOW of the green candlestick are within the bodies of the red candles.

Implication: It often happens when the buy side tries to rebound but fails, and it results in a heavier sell. It often confirms a downtrend.

Reminder: Watch if heavy weight sellers stop their shorts as an early sign of reversal.

As shown in FIG. 17R, a “Bear & 3 Calves” is shown.

Definition: One big bear engulfs three calves. After three days' ups, the OPEN is high again, but then falls sharply to a LOW, and the CLOSE is lower than the LOW of the three green candles.

Implication: The selling power regains control and turns the trend downward, especially when the volume of the big red is about the sum of the three greens. The subsequent rebound is hard to overcome the HIGH of this bear, if the volume of the bear is really large.

Reminder: If the subsequent rebound overcomes the HIGH with volume, then the buy side takes control again.

As shown in FIG. 17S, a “Bear Island” is shown.

Definition: In the uptrend, a gap up followed by a gap down. It is like a bear island in the bull sea.

Implication: The gap is often caused by certain news after previous session is closed, or driven by heavy weight buyers or sellers to the direction they want. A bull gap is a gap up and a green candle, with today's LOW higher than yesterday's HIGH. A bear gap is a gap down and a red candle, with today's HIGH lower than yesterday's LOW. A bull gap follows immediately by a bear gap is a strong reversal signal. It is often followed by a downtrend. As long as the price does not go back above the bear gap, you can consider staying on the sell side or shorting.

Reminder: Though unlikely, if the price pulls back up the bear gap, it may be time to buy.

As shown in FIG. 17T, a “Tumble Down” is shown.

Definition: A big bear appears after a long flat-trend.

Implication: It indicates the buying power lost steam. It may be the beginning of a bearish run. It may be time to sell or consider shorting.

Reminder: Watch subsequent development carefully. It may be a fake tumble down with just one big bear.

As shown in FIG. 17U, a “Long Spike Top” is shown.

Definition: A long upper shadow with the OPEN higher than yesterday's CLOSE is in the uptrend, and the price keeps going up to the highest HIGH on the current uptrend, but the price goes down sharply and the CLOSE is at or near the OPEN.

Implication: It is often the case when the buy side runs out of stream or is ready to take profits. If it is followed by another long up shadow and forms a Bear Teeth, then it becomes a strong sign of a top.

Reminder: In the downtrend, to reverse the trend, the volume often has to be reduced to a very small amount. So, once the trend turns here and there's bounce back, look at the volume.

As shown in FIG. 17V, a “Bear Brewing” is shown.

Definition: A big bear follows by three small rises or falls, but none of the three days' HIGHs went above the mid-point of the big bear.

Implication: It indicates the resting of the sell side, but the bear may be ready to attack again. If the volume is reduced during the three-day rest, the following attack may be stronger.

Reminder: If there are high volumes in the three days, then the direction is not as certain.

As shown in FIG. 17W, a “Calf Stand Up” is shown.

Definition: A gap down with the OPEN having a gap down but the CLOSE higher than the OPEN is in the downtrend, and the body of the green candlestick is smaller than the bodies of the previous two red candles. It is like a small calf stands up to fight.

Implication: It is too weak to be a reversal sign. Do not become a big buyer immediately. If the volume is low, the calf cannot reverse the trend, and the downtrend continues.

Reminder: If the volume is high, watch out for a bounce. If the volume is very high, even though the price change is small, then the buyers become active, and the downtrend may not hold. In this case, watch out for small cap manipulation.

As shown in FIG. 17X, a “Bear Invade” is shown.

Definition: A large green candlestick hit a recent high in an uptrend, but followed by two red candles, one smaller than the other. The larger red candlestick enters the railing of the bulls, with its CLOSE lower than the LOW of the green candle.

Implication: It indicates the price may start to crumble, and the sell side has the upper hand. If the volume is very high, it could be a reversal sign and a top is shaped.

Reminder: It is not a solid sign if the volume is smaller than the green candle. If it bounce back later but the HIGH does not reach the HIGH of the green candle, it may fall back down harder.

Accordingly, by providing the securities information processing system and method in accordance with the present invention, the user can sort specific securities that meet the candlesticks checking conditions, and can configure the manipulation of the candlesticks checking conditions by pictures or any visional medium the like, such that the user can judge in a straight forward manner (without tedious pondering or mathematical computations) which securities or the preset candlesticks checking condition is met and is good for trading. Thereby, even for an ordinary people without sophistic securities knowledge, he/she can still employ the securities information processing system and method to determine a preferred timing or pricing for selling or buying his/her securities. Through the aforesaid fuzzy checking provided by the present invention, a considerable amount of securities information can be located to fulfill the securities suggesting condition configured by the user, so that checking results with better reference values can be obtained.

While the present invention has been particularly shown and described with reference to a preferred embodiment, it will be understood by those skilled in the art that various changes in form and detail may be without departing from the spirit and scope of the present invention.

What is claimed is:

1. A processing method for fuzzy checking securities information, applied to a user device of a securities information processing system, comprising the steps of:
Step (A): Setting at least one securities suggesting condition in the user device and the user device receiving a plurality of foreign securities information; wherein each of the at least one securities suggesting condition includes at least one candlesticks checking condition and each of the at least one candlesticks checking condition further includes an OPEN position, a CLOSE position, a HIGH position, a LOW position and at least one fuzzy checking condition of foregoing meaningful positions in a predetermined time period; wherein the OPEN position, the CLOSE position, the HIGH position and the LOW position are all expressed by relative percentages not absolute values; wherein a difference between the HIGH position and the LOW position of each of the at least one candlesticks checking condition is no more than twice of a predetermined price limit; wherein each of the plurality of securities information includes at least one trading information of a security within a specific time duration, and the specific time duration larger than the predetermined time period is divided into a plurality of the predetermined time periods; wherein, in each of the plurality of the predetermined time periods, the at least one trading information further includes an OPEN, a CLOSE, a HIGH and a LOW, and each of the OPEN, the CLOSE, the HIGH and the LOW is expressed by an absolute value; and
Step (B): the user device analyzing each of the plurality of securities information and checking if any of the securities information meets any of the at least one securities suggesting condition in the at least one fuzzy checking condition of the meaningful positions of every one of the at least one candlesticks checking condition thereof, and issuing an alarm signal if positive by accompanying an operation of displaying the any of the securities information on the user device;
wherein the at least one fuzzy checking condition of the meaningful positions includes an upper-shadow-line fuzzy checking condition, a solid-line fuzzy checking condition and a lower-shadow-line fuzzy checking condition;
wherein the upper-shadow-line fuzzy checking condition is derived in percentage terms by dividing a value of subtracting the larger one of the OPEN and the CLOSE from the HIGH by the OPEN;
wherein the solid-line fuzzy checking condition is derived in percentage terms by dividing an absolute value of the difference between the OPEN and the CLOSE by the OPEN;
wherein the lower-shadow-line fuzzy checking condition is derived in percentage terms by dividing a value of substracting the LOW from the smaller one of the OPEN and the CLOSE by the OPEN.

2. The processing method for fuzzy checking securities information of claim 1, wherein the user device further includes a touch screen, the securities suggesting condition is able to be configured by one user of the user device, and configuring of the securities suggesting condition includes the steps of:
Step (A1): executing a securities suggesting setting function;
Step (A2): the securities suggesting setting function displaying a plurality of neighboring initial candlesticks on the touch screen;
Step (A3): if any one of the plurality of initial candlesticks is clicked, entering a candlestick adjusting function of the clicked initial candle, and displaying at least an enlarged candlestick of the clicked initial candlestick on the touch screen; wherein the enlarged candlestick has an OPEN touch point, a CLOSE touch point, a HIGH touch point and a LOW touch point, and the OPEN touch point, the CLOSE touch point, the HIGH touch point and the LOW touch point are individually referred to respective percentages;
Step (A4): checking if a depress-and-pull operation is performed by the user on any one of the OPEN touch point, the CLOSE touch point, the HIGH touch point and the LOW touch point of the enlarged candle, adjusting, if positive, the percentage corresponding to the any one of the OPEN touch point, the CLOSE touch point, the HIGH touch point and the LOW touch point of the enlarged candlestick according to the user till the depress-and-pull operation ends, then adjusting a color and a shape of the enlarged candlestick according to a result of user's depress-and-pull operation so as to form an adjusted candle, and replacing the enlarged candlestick with the adjusted candlestick on the touch screen;
Step (A5): going back to Step (A3), replacing the clicked intial candlestick on the touch screen with a minimized candlestick of the adjusted candlestick of Step (A4); and
Step (A6): repeating Step (A3) to Step (A5) till the user completes all candle-adjustment upon the plurality of the initial candles, and then assigning respective percentages corresponding to the OPEN touch point, the CLOSE touch point, the HIGH touch point and the LOW touch point of each of the adjusted candlesticks to update the respective candlesticks checking condition.

3. The processing method for fuzzy checking securities information of claim 2, wherein the depress-and-pull operation in the Step (A4) is performed by pulling up and down to change the respective percentage;
wherein, as the depress-and-pull operation is performed upon the enlarged candlestick directly on the touch screen, the entire enlarged candlestick as well as the OPEN touch point, the CLOSE touch point, the HIGH touch point and the LOW touch point are all synchronously pulled;
wherein, as the depress-and-pull operation is performed only upon the OPEN touch point on the touch screen, only the OPEN touch point is pulled;
wherein, as the depress-and-pull operation is performed only upon the CLOSE touch point on the touch screen, only the CLOSE touch point is pulled;
wherein, as the depress-and-pull operation is performed only upon the HIGH touch point on the touch screen, only the HIGH touch point is pulled;
wherein, as the depress-and-pull operation is performed only upon the LOW touch point on the touch screen, only the LOW touch point is pulled;
wherein, as the OPEN touch point is positioned higher that the CLOSE touch point, the enlarged candlestick is green;
wherein, as the OPEN touch point is positioned lower that the CLOSE touch point, the enlarged candlestick is red; and
wherein, as the depress-and-pull operation leads to a high-low position switch between the OPEN touch point and the CLOSE touch point, the color of the enlarged candlestick is changed as well.

4. The processing method for fuzzy checking securities information of claim 3, wherein, in the Step (A4), as the depress-and-pull operation is performed simultaneously upon the HIGH touch point and the LOW touch point on the touch screen, the OPEN touch point, the CLOSE touch point, the HIGH touch point and the LOW touch point of the enlarged candlestick are proportionally changed accordingly.

5. The processing method for fuzzy checking securities information of claim 2, wherein, in the Step (A3), as the candlestick adjusting function is performed, the touch screen shows the enlarged candlestick and some mini candlesticks with preset colors and sizes; and wherein, as any one of the mini candlestick is clicked, the color and size of the clicked mini candlestick is applied to the enlarged candle.

6. The processing method for fuzzy checking securities information of claim 2, wherein, between the Step (A4) and the Step (A5), a Step (A4a) is further included as follows:
displaying the enlarged candlestick, a corresponding input block of the upper-shadow-line fuzzy checking condition, a corresponding input block of the solid-line fuzzy checking condition and a corresponding input block of the lower-shadow-line fuzzy checking condition on the touch screen;
wherein the user clicks the input block of the upper-shadow-line fuzzy checking condition to configure the upper-shadow-line fuzzy checking condition to be one of a value substantially equal to a percentage value, a value larger than a percentage value, a value smaller than a percentage value and an arbitrary length;
wherein the user clicks the input block of the solid-line fuzzy checking condition to configure the solid-line fuzzy checking condition to be one of a value substantially equal to a percentage value, a value larger than a percentage value, a value smaller than a percentage value and an arbitrary length;
wherein the user clicks the input block of the lower-shadow-line fuzzy checking condition to configure the lower-shadow-line fuzzy checking condition to be one of a value substantially equal to a percentage value, a value larger than a percentage value, a value smaller than a percentage value and an arbitrary length.

7. The processing method for fuzzy checking securities information of claim 1, wherein the securities suggesting condition is preset in the user device in advance.

8. A processing method for fuzzy checking securities information, employed in a user device of a securities information processing system, the user device having a touch screen, comprising a Step (A) of setting at least one securities suggesting condition into the user device, wherein the Step (A) further includes the steps of:
Step (A1): executing a securities suggesting setting function;
Step (A2): the securities suggesting setting function displaying a plurality of neighboring initial candlesticks on the touch screen;
Step (A3): if any one of the plurality of initial candlesticks is clicked, entering a candlestick adjusting function of the clicked initial candle, and displaying at least an enlarged candlestick of the clicked initial candlestick on the touch screen; wherein the enlarged candlestick has an OPEN touch point, a CLOSE touch point, a HIGH touch point and a LOW touch point, and the OPEN touch point, the CLOSE touch point, the HIGH touch point and the LOW touch point are individually referred to respective percentages;
Step (A4): checking if a depress-and-pull operation is performed by the user on any one of the OPEN touch point, the CLOSE touch point, the HIGH touch point and the LOW touch point of the enlarged candle, adjusting, if positive, the percentage corresponding to the any one of the OPEN touch point, the CLOSE touch point, the HIGH touch point and the LOW touch point of the enlarged candlestick according to the user till the depress-and-pull operation ends, then adjusting a color and a shape of the enlarged candlestick according to a result of user's depress-and-pull operation so as to form an adjusted candle, and replacing the enlarged candlestick with the adjusted candlestick on the touch screen;
Step (4Aa): displaying the enlarged candlestick, a corresponding input block of the upper-shadow-line fuzzy checking condition, a corresponding input block of the solid-line fuzzy checking condition and a corresponding input block of the lower-shadow-line fuzzy checking condition on the touch screen; wherein the user clicks the input block of the upper-shadow-line fuzzy checking condition to configure the upper-shadow-line fuzzy checking condition to be one of a value substantially equal to a percentage value, a value larger than a percentage value, a value smaller than a percentage value and an arbitrary length; wherein the user clicks the input block of the solid-line fuzzy checking condition to configure the solid-line fuzzy checking condition to be one of a value substantially equal to a percentage value, a value larger than a percentage value, a value smaller than a percentage value and an arbitrary length; wherein the user clicks the input block of the lower-shadow-line fuzzy checking condition to configure the lower-shadow-line fuzzy checking condition to be one of a value substantially equal to a percentage value, a value larger than a percentage value, a value smaller than a percentage value and an arbitrary length;
Step (A5): going back to Step (A3), replacing the clicked initial candlestick on the touch screen with a minimized candlestick of the adjusted candlestick of Step (A4); and
Step (A6): repeating Step (A3) to Step (A5) till the user completes all candle-adjustment upon the plurality of the initial candles, and then assigning respective percentages corresponding to the OPEN touch point, the CLOSE touch point, the HIGH touch point and the LOW touch point of each of the adjusted candlesticks to update the respective candlesticks checking condition.

9. The processing method for fuzzy checking securities information of claim 8, wherein the Step (A) further includes the step of:
setting at least one securities suggesting condition in the user device and the user device receiving a plurality of foreign securities information; wherein each of the at least one securities suggesting condition includes at least one candlesticks checking condition and each of the at least one candlesticks checking condition further includes an OPEN position, a CLOSE position, a HIGH position, a LOW position and at least one fuzzy checking condition of foregoing meaningful positions in a predetermined time period; wherein the OPEN position, the CLOSE position, the HIGH position and the LOW position are all expressed by relative percentages not absolute values; wherein a difference between the HIGH position and the LOW position of each of the at least one candlesticks checking condition is no more than twice of a predetermined price limit; wherein each of the plurality of securities information includes at least one trading information of a security within a specific time duration, and the specific time duration larger than the predetermined time period is divided into a plurality of the predetermined time periods; wherein, in each of the plurality of the predetermined time periods, the at least one trading information further includes an OPEN, a CLOSE, a HIGH and a LOW, and each of the OPEN, the CLOSE, the HIGH and the LOW is expressed by an absolute value; and
the user device analyzing each of the plurality of securities information and checking if any of the securities information meets any of the at least one securities suggesting condition in the at least one fuzzy checking condition of the meaningful positions of every one of the at least one candlesticks checking condition thereof, and issuing an alarm signal if positive by accompanying an operation of displaying the any of the securities information on the user device;
wherein the at least one fuzzy checking condition of the meaningful positions includes an upper-shadow-line fuzzy checking condition, a solid-line fuzzy checking condition and a lower-shadow-line fuzzy checking condition;
wherein the upper-shadow-line fuzzy checking condition is derived in percentage terms by dividing a value of subtracting the larger one of the OPEN and the CLOSE from the HIGH by the OPEN;
wherein the solid-line fuzzy checking condition is derived in percentage terms by dividing an absolute value of the difference between the OPEN and the CLOSE by the OPEN;
wherein the lower-shadow-line fuzzy checking condition is derived in percentage terms by dividing a value of substracting the LOW from the smaller one of the OPEN and the CLOSE by the OPEN.

10. The processing method for fuzzy checking securities information of claim 8, wherein the depress-and-pull operation in the Step (A4) is performed by pulling up and down to change the respective percentage;
wherein, as the depress-and-pull operation is performed upon the enlarged candlestick directly on the touch screen, the entire enlarged candlestick as well as the OPEN touch point, the CLOSE touch point, the HIGH touch point and the LOW touch point are all synchronously pulled;
wherein, as the depress-and-pull operation is performed only upon the OPEN touch point on the touch screen, only the OPEN touch point is pulled;
wherein, as the depress-and-pull operation is performed only upon the CLOSE touch point on the touch screen, only the CLOSE touch point is pulled;
wherein, as the depress-and-pull operation is performed only upon the HIGH touch point on the touch screen, only the HIGH touch point is pulled;
wherein, as the depress-and-pull operation is performed only upon the LOW touch point on the touch screen, only the LOW touch point is pulled;
wherein, as the OPEN touch point is positioned higher that the CLOSE touch point, the enlarged candlestick is green;
wherein, as the OPEN touch point is positioned lower that the CLOSE touch point, the enlarged candlestick is red; and
wherein, as the depress-and-pull operation leads to a high-low position switch between the OPEN touch point and the CLOSE touch point, the color of the enlarged candlestick is changed as well.

11. The processing method for fuzzy checking securities information of claim 10, wherein, in the Step (A4), as the depress-and-pull operation is performed simultaneously upon the HIGH touch point and the LOW touch point on the touch screen, the OPEN touch point, the CLOSE touch point, the HIGH touch point and the LOW touch point of the enlarged candlestick are proportionally changed accordingly.

12. The processing method for fuzzy checking securities information of claim 8, wherein, in the Step (A3), as the candlestick adjusting function is performed, the touch screen shows the enlarged candlestick and some mini candlesticks with preset colors and sizes; and wherein, as any one of the mini candlestick is clicked, the color and size of the clicked mini candlestick is applied to the enlarged candle.

13. A processing method for fuzzy checking securities information, employed in a securities information processing system having a server and at least one user device, the server being to receive a plurality of foreign securities information, comprising the steps of:
Step (a): Setting at least one securities suggesting condition in the user device and the user device receiving a plurality of foreign securities information; wherein each of the at least one securities suggesting condition includes at least one candlesticks checking condition and each of the at least one candlesticks checking condition further includes an OPEN position, a CLOSE position, a HIGH position, a LOW position and at least one fuzzy checking condition of foregoing meaningful positions in a predetermined time period; wherein the OPEN position, the CLOSE position, the HIGH position and the LOW position are all expressed by relative percentages not absolute values; wherein a difference between the HIGH position and the LOW position of each of the at least one candlesticks checking condition is no more than twice of a predetermined price limit; wherein each of the plurality of securities information includes at least one trading information of a security within a specific time duration, and the specific time duration larger than the predetermined time period is divided into a plurality of the predetermined time periods; wherein, in each of the plurality of the predetermined time periods, the at least one trading information further includes an OPEN, a CLOSE, a HIGH and a LOW, and each of the OPEN, the CLOSE, the HIGH and the LOW is expressed by an absolute value;
Step (b): the user device sending the at least one securities suggesting condition to the server; and
Step (c): the user device analyzing each of the plurality of securities information and checking if any of the securities information meets any of the at least one securities suggesting condition in the at least one fuzzy checking condition of the meaningful positions of every one of the at least one candlesticks checking condition thereof, the any of securities information that meets the securities suggesting condition being forwarded back to the user device, and the any of the securities information being displayed on the user device;
wherein the at least one fuzzy checking condition of the meaningful positions includes an upper-shadow-line fuzzy checking condition, a solid-line fuzzy checking condition and a lower-shadow-line fuzzy checking condition;
wherein the upper-shadow-line fuzzy checking condition is derived in percentage terms by dividing a value of subtracting the larger one of the OPEN and the CLOSE from the HIGH by the OPEN;
wherein the solid-line fuzzy checking condition is derived in percentage terms by dividing an absolute value of the difference between the OPEN and the CLOSE by the OPEN;
wherein the lower-shadow-line fuzzy checking condition is derived in percentage terms by dividing a value of substracting the LOW from the smaller one of the OPEN and the CLOSE by the OPEN.

14. The processing method for fuzzy checking securities information of claim 13, wherein the user device further includes a touch screen, the securities suggesting condition is able to be configured by one user of the user device, and configuring of the securities suggesting condition includes the steps of:
Step (A1): executing a securities suggesting setting function;
Step (A2): the securities suggesting setting function displaying a plurality of neighboring initial candlesticks on the touch screen;
Step (A3): if any one of the plurality of initial candlesticks is clicked, entering a candlestick adjusting function of the clicked initial candle, and displaying at least an enlarged candlestick of the clicked initial candlestick on the touch screen; wherein the enlarged candlestick has an OPEN touch point, a CLOSE touch point, a HIGH touch point and a LOW touch point, and the OPEN touch point, the CLOSE touch point, the HIGH touch point and the LOW touch point are individually referred to respective percentages;
Step (A4): checking if a depress-and-pull operation is performed by the user on any one of the OPEN touch point, the CLOSE touch point, the HIGH touch point and the LOW touch point of the enlarged candle, adjusting, if positive, the percentage corresponding to the any one of the OPEN touch point, the CLOSE touch point, the HIGH touch point and the LOW touch point of the enlarged candlestick according to the user till the depress-and-pull operation ends, then adjusting a color and a shape of the enlarged candlestick according to a result of user's depress-and-pull operation so as to form an adjusted candle, and replacing the enlarged candlestick with the adjusted candlestick on the touch screen;
Step (A5): going back to Step (A3), replacing the clicked initial candlestick on the touch screen with a minimized candlestick of the adjusted candlestick of Step (A4); and
Step (A6): repeating Step (A3) to Step (A5) till the user completes all candle-adjustment upon the plurality of the initial candles, and then assigning respective percentages corresponding to the OPEN touch point, the CLOSE touch point, the HIGH touch point and the LOW touch point of each of the adjusted candlesticks to update the respective candlesticks checking condition.

15. The processing method for fuzzy checking securities information of claim 14, wherein the depress-and-pull operation in the Step (A4) is performed by pulling up and down to change the respective percentage;
wherein, as the depress-and-pull operation is performed upon the enlarged candlestick directly on the touch screen, the entire enlarged candlestick as well as the OPEN touch point, the CLOSE touch point, the HIGH touch point and the LOW touch point are all synchronously pulled;
wherein, as the depress-and-pull operation is performed only upon the OPEN touch point on the touch screen, only the OPEN touch point is pulled;
wherein, as the depress-and-pull operation is performed only upon the CLOSE touch point on the touch screen, only the CLOSE touch point is pulled;
wherein, as the depress-and-pull operation is performed only upon the HIGH touch point on the touch screen, only the HIGH touch point is pulled;
wherein, as the depress-and-pull operation is performed only upon the LOW touch point on the touch screen, only the LOW touch point is pulled;
wherein, as the OPEN touch point is positioned higher that the CLOSE touch point, the enlarged candlestick is green;
wherein, as the OPEN touch point is positioned lower that the CLOSE touch point, the enlarged candlestick is red; and
wherein, as the depress-and-pull operation leads to a high-low position switch between the OPEN touch point and the CLOSE touch point, the color of the enlarged candlestick is changed as well.

16. The processing method for fuzzy checking securities information of claim 15, wherein, in the Step (A4), as the depress-and-pull operation is performed simultaneously upon the HIGH touch point and the LOW touch point on the touch screen, the OPEN touch point, the CLOSE touch point, the HIGH touch point and the LOW touch point of the enlarged candlestick are proportionally changed accordingly.

17. The processing method for fuzzy checking securities information of claim 14, wherein, in the Step (A3), as the candlestick adjusting function is performed, the touch screen shows the enlarged candlestick and some mini candlesticks with preset colors and sizes; and wherein, as any one of the mini candlestick is clicked, the color and size of the clicked mini candlestick is applied to the enlarged candle.

18. The processing method for fuzzy checking securities information of claim 14, wherein, between the Step (A4) and the Step (A5), a Step (A4a) is further included as follows:
displaying the enlarged candlestick, a corresponding input block of the upper-shadow-line fuzzy checking condition, a corresponding input block of the solid-line fuzzy checking condition and a corresponding input block of the lower-shadow-line fuzzy checking condition on the touch screen;
wherein the user clicks the input block of the upper-shadow-line fuzzy checking condition to configure the upper-shadow-line fuzzy checking condition to be one of a value substantially equal to a percentage value, a value larger than a percentage value, a value smaller than a percentage value and an arbitrary length;
wherein the user clicks the input block of the solid-line fuzzy checking condition to configure the solid-line fuzzy checking condition to be one of a value substantially equal to a percentage value, a value larger than a percentage value, a value smaller than a percentage value and an arbitrary length;
wherein the user clicks the input block of the lower-shadow-line fuzzy checking condition to configure the lower-shadow-line fuzzy checking condition to be one of a value substantially equal to a percentage value, a value larger than a percentage value, a value smaller than a percentage value and an arbitrary length.

19. A processing method for fuzzy checking securities information, employed in a securities information processing system having a server and at least one user device, the server and the at least one user device being to receive a plurality of foreign historical securities trading information, comprising the steps of:
Step (1): storing a plurality of securities suggesting conditions into at least one of the server and the user device; wherein each of the plurality of the securities suggesting conditions further includes at least one candlesticks checking condition, each of the at least one candlesticks checking condition further includes an OPEN position, a CLOSE position, a HIGH position, a LOW position and at least one fuzzy checking condition of foregoing meaningful positions and at least one fuzzy checking condition of foregoing meaningful positions in a predetermined time period; wherein the OPEN position, the CLOSE position, the HIGH position and the LOW position are all expressed by relative percentages not absolute values; wherein a difference between the HIGH position and the LOW position of each of the at least one candlesticks checking condition is no more than twice of a predetermined price limit; wherein each of the plurality of securities information includes at least one trading information of a security within a specific time duration, and the specific time duration larger than the predetermined time period is divided into a plurality of the predetermined time periods; wherein, in each of the plurality of the predetermined time periods, the at least one trading information further includes an OPEN, a CLOSE, a HIGH and a LOW, and each of the OPEN, the CLOSE, the HIGH and the LOW is expressed by an absolute value;
Step (2): manipulating the user device to choose a security; and
Step (3): checking if the historical trading information of the chosen security meets any one of the securities suggesting conditions, displaying a historical candlesticks chart of the chosen security if positive, and labeling the any one of the securities suggesting conditions in the historical candlesticks chart;
wherein the at least one fuzzy checking condition of the meaningful positions includes an upper-shadow-line fuzzy checking condition, a solid-line fuzzy checking condition and a lower-shadow-line fuzzy checking condition;
wherein the upper-shadow-line fuzzy checking condition is derived in percentage terms by dividing a value of subtracting the larger one of the OPEN and the CLOSE from the HIGH by the OPEN;
wherein the solid-line fuzzy checking condition is derived in percentage terms by dividing an absolute value of the difference between the OPEN and the CLOSE by the OPEN;
wherein the lower-shadow-line fuzzy checking condition is derived in percentage terms by dividing a value of substracting the LOW from the smaller one of the OPEN and the CLOSE by the OPEN.

20. The processing method for fuzzy checking securities information of claim 18, wherein the user device further forwards at least one of a name and a code of the chosen security to the server in the Step (2), the Step (3) is executed by the server, and the server sends a result of the Step (3) back to the user device.
